(19) United States
(12) Patent Application Publication
(10) Pub. No.: US 2025/0360630 A1
(43) Pub. Date: Nov. 27, 2025

(54) ROBOT AND METHOD FOR CONTROLLING ROBOT

(71) Applicant: SONY GROUP CORPORATION, Tokyo (JP)

(72) Inventor: Yoshinao SODEYAMA, Tokyo (JP)

(73) Assignee: SONY GROUP CORPORATION, Tokyo (JP)

(21) Appl. No.: 18/874,597

(22) PCT Filed: Jun. 13, 2023
(86) PCT No.: PCT/JP2023/021835

§ 371 Date: Dec. 13, 2024

(30) Foreign Application Priority Data
Jun. 29, 2022 (JP) 2022-104294

(51) Int. Cl. B25J 11/00

(52) U.S. Cl. CPC B25J 11/0015

(57) ABSTRACT

There is provided a robot and a method for controlling a robot that enable smooth dialogue between the robot and a user. The robot includes: a head part; a torso part including a waist having a lumbar joint axis capable of rotating in at least a pitch direction; a neck provided between the head part and the torso part, and including a neck joint axis capable of rotating in at least the pitch direction; a base part supporting the torso part; and an action control unit that controls a peering action of peering at a face of a user by controlling the neck joint axis and the lumbar joint axis. The present technique can be applied, for example, in a care robot that cares for a subject to be cared for.

### TECHNICAL FIELD

The present technique relates to a robot and a method for controlling a robot, and particularly relates to a robot capable of dialogue with a user and a method for controlling such a robot.

### BACKGROUND ART

The development of humanoid robots having multiple joints has progressed in recent years (see, for example, PTL 1).

### CITATION LIST

### Patent Literature

PTL 1: JP 2020-204890A

### SUMMARY

### Technical Problem

It is expected that in the future, humanoid robots will be introduced at caregiving sites and will be able to engage in dialogue with users whose cognitive function has decreased, such as the elderly, people with disabilities, and people with dementia (referred to as “cognitively-impaired people” hereinafter).

Having been achieved in light of such circumstances, the present technique makes it possible for a robot to engage in dialogue smoothly with a user such as a cognitively-impaired person.

### Solution to Problem

A robot according to one aspect of the present technique includes: a head part; a torso part including a waist having a lumbar joint axis capable of rotating in at least a pitch direction; a neck provided between the head part and the torso part, and including a neck joint axis capable of rotating in at least the pitch direction; a base part supporting the torso part; and an action control unit that controls a peering action of peering at a face of a user by controlling the neck joint axis and the lumbar joint axis.

A method for controlling a robot according to one aspect of the present technique causes a robot including a head part, a torso part including a waist having a lumbar joint axis capable of rotating in at least a pitch direction, a neck provided between the head part and the torso part and including a neck joint axis capable of rotating in at least the pitch direction, and a base part supporting the torso part, to execute a peering action of peering at a face of a user by controlling the neck joint axis and the lumbar joint axis.

In one aspect of the present technique, a robot including a head part, a torso part including a waist having a lumbar joint axis capable of rotating in at least a pitch direction, a neck provided between the head part and the torso part and including a neck joint axis capable of rotating in at least the pitch direction, and a base part supporting the torso part, executes a peering action of peering at a face of a user by controlling the neck joint axis and the lumbar joint axis.

### BRIEF DESCRIPTION OF DRAWINGS

FIG. 1 is a front view and a left side view of a care robot to which the present technique is applied, in a normal posture.

FIG. 2 is a rear view of the care robot in the normal posture.

FIG. 3 is a perspective view of the care robot in the normal posture, viewed from a right diagonal front direction.

FIG. 4 is a perspective view of the care robot in the normal posture, viewed from a left diagonal rear direction.

FIG. 5 is a diagram comparing the care robot with the size of a typical table.

FIG. 6 is an enlarged view of the head part of the care robot.

FIG. 7 is an exploded view illustrating an example of the internal configuration of an eyeball part of the care robot.

FIG. 8 is an exterior view of an arm part of the care robot.

FIG. 9 is an exterior view of a hand of the care robot.

FIG. 10 is a front view of a care robot equipped with a hand display.

FIG. 11 is a right side view of the care robot equipped with a hand display.

FIG. 12 is an exterior view of the upper body of the care robot equipped with a hand display.

FIG. 13 is a perspective view illustrating exterior features of the care robot.

FIG. 14 is a front view illustrating exterior features of the care robot.

FIG. 15 is a front view illustrating positions of dimensions of each part of the care robot.

FIG. 16 is a left side view illustrating positions of dimensions of each part of the care robot.

FIG. 17 is a left side view illustrating positions of dimensions of each part of the care robot, with an arm part thereof not shown.

FIG. 18 is a diagram illustrating an example of optimal values for dimensions, optimal dimensional ratios, and a permissible range of dimensional ratios, for each part of the care robot.

FIG. 19 is a diagram illustrating an example of optimal values for dimensions, optimal dimensional ratios, and a permissible range of dimensional ratios, for each part of the care robot.

FIG. 20 is a diagram illustrating an example of optimal values for dimensions, optimal dimensional ratios, and a permissible range of dimensional ratios, for each part of the care robot.

FIG. 21 is a diagram illustrating an example of optimal values for dimensions, optimal dimensional ratios, and a permissible range of dimensional ratios, for each part of the care robot.

FIG. 22 is a diagram illustrating an example of a movement range for each of joint axes of the care robot.

FIG. 23 is a schematic diagram illustrating the shape of the care robot when viewed from the side.

FIG. 24 is a block diagram schematically illustrating an example of the configuration of a robot operation system to which the present technique is applied.

FIG. 25 is a flowchart illustrating the basic flow of dialogical interaction processing executed by the care robot.

FIG. 26 is a diagram illustrating a specific example of dialogical interaction processing.

FIG. 27 is a left side view of the care robot in the normal posture.

FIG. 28 is a diagram illustrating a specific example of dialogical interaction processing.

FIG. 29 is a diagram illustrating a specific example of dialogical interaction processing.

FIG. 30 is a left side view of the care robot in a peering posture.

FIG. 31 is a left side view of the care robot in a peering posture.

FIG. 32 is a left side view of the care robot in a peering posture.

FIG. 33 is a block diagram illustrating an example of the configuration of a computer.

### DESCRIPTION OF EMBODIMENTS

An embodiment of the present technique will be described in detail hereinafter with reference to the drawings. Here, the descriptions will be given in the following order.
1. Embodiment
2. Variations
3. Other

### 1. Embodiment

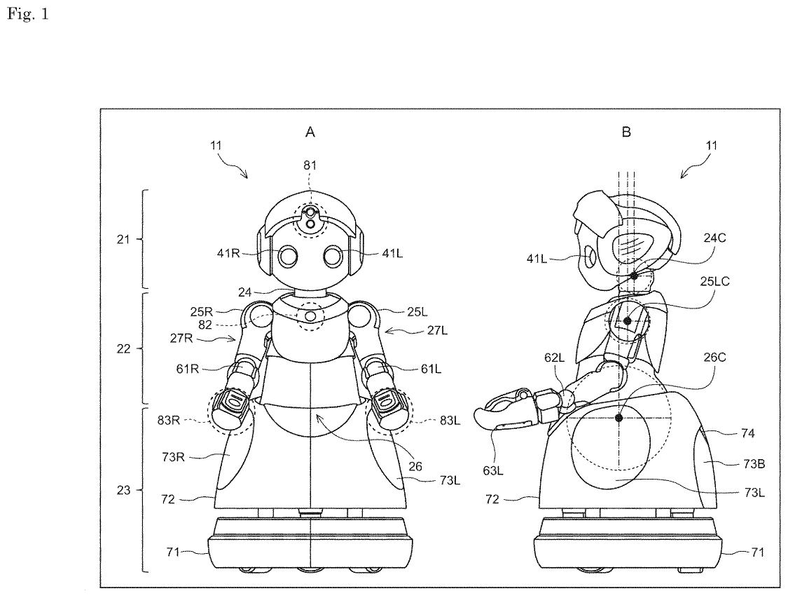

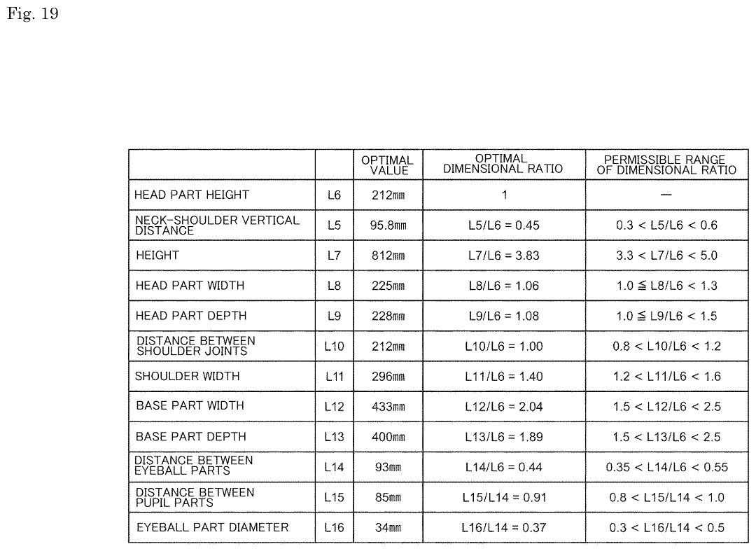

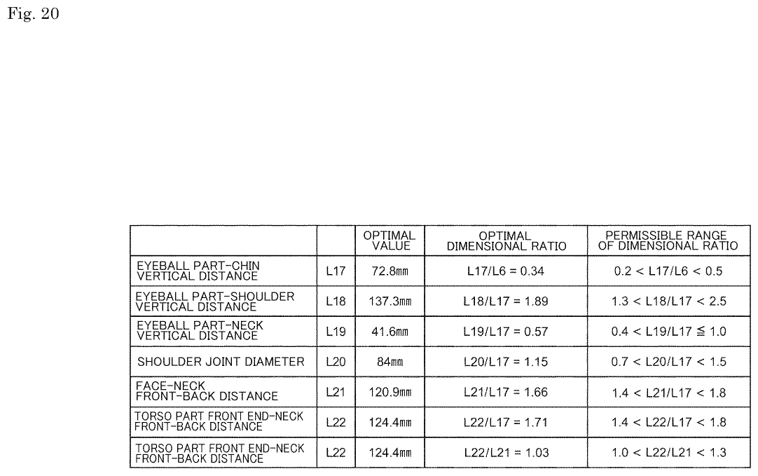

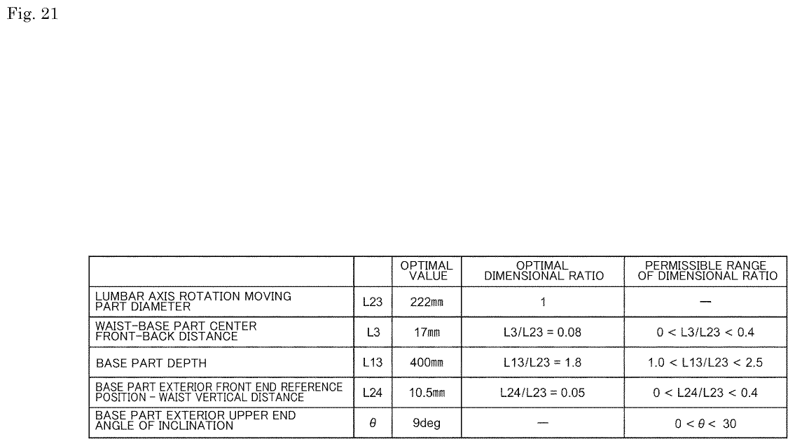

An embodiment of the present technique will be described with reference to FIGS. 1 to 32.

### <Example of Configuration of Care Robot 11>

An example of the configuration of a care robot 11 serving as an embodiment of the present technique will be described first with reference to FIGS. 1 to 22.

The care robot 11 is a humanoid mobile manipulator robot capable of using “humanitude” to perform various types of applications, such as various types of care, condition observation, communication, and related work tasks, at a level of quality to which subjects are highly receptive.

For example, the care robot 11 performs various applications for performing care actions in accordance with a scheduler created under the judgment of care staff and individual robot operation settings made for each subject. Applications the care robot 11 is capable of performing include, for example, greeting a subject to calm down, measuring vital signs, music therapy, making telephone calls, and the like. The applications the care robot 11 is capable of performing include applications for interacting with subjects through dialogue (called “dialogical interactions” hereinafter). The care robot 11 is configured to be capable of performing applications aimed at preventing subjects from becoming unstable, and providing a stabilizing effect on subjects' daily rhythm.

Note that the care robot 11 may, for example, conduct dialogue on the basis of scenarios prepared in advance, or may conduct natural dialogue according to the situation using artificial intelligence or the like. Additionally, for example, a person may conduct dialogue through the care robot 11 by operating the care robot 11 remotely in real time.

### <Example of External Appearance of Care Robot 11>

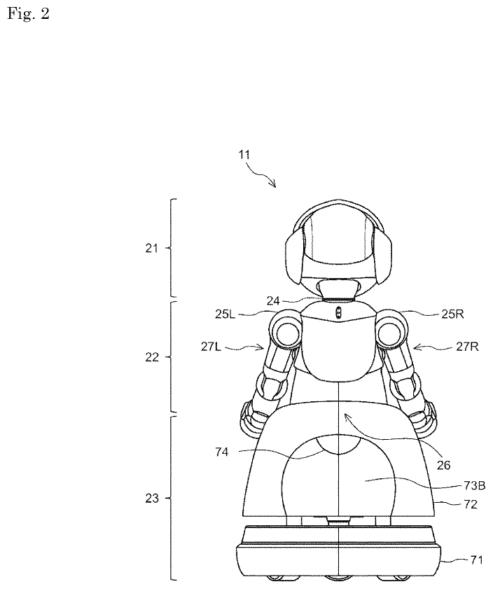

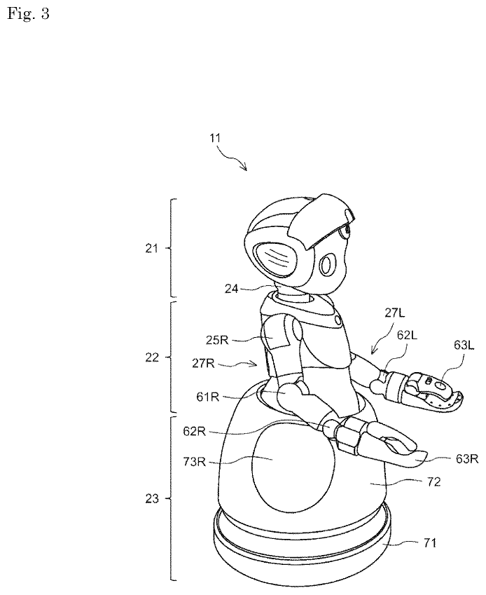

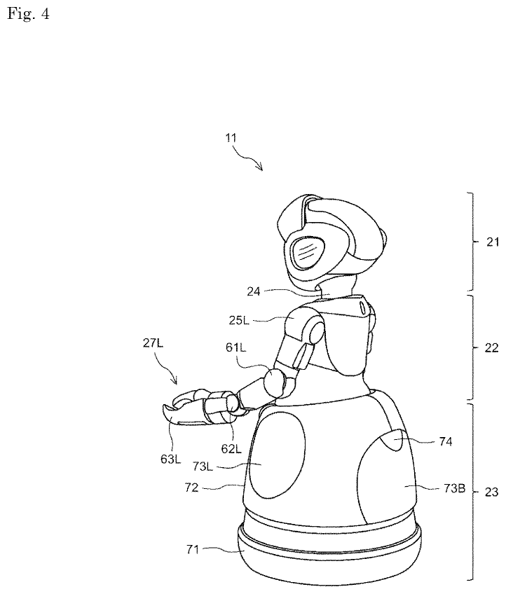

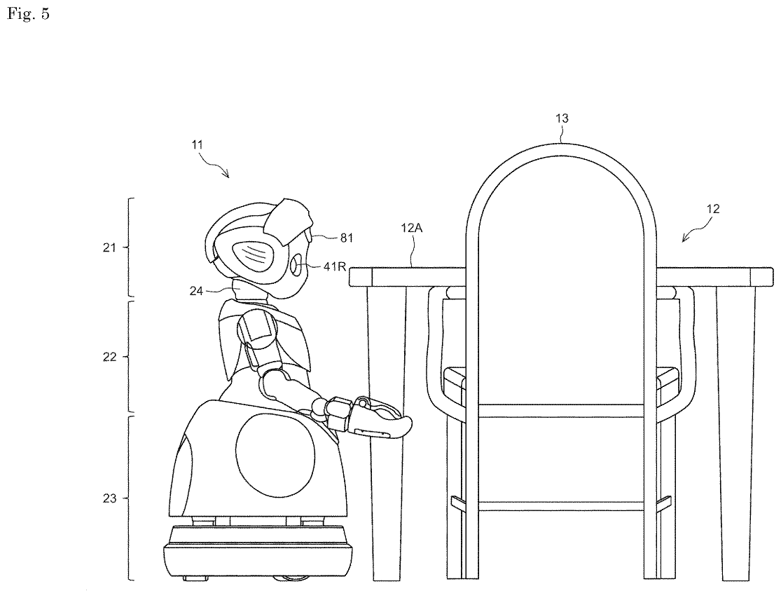

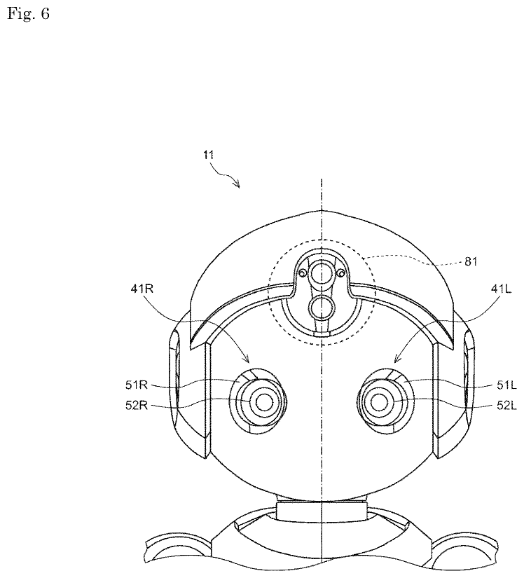

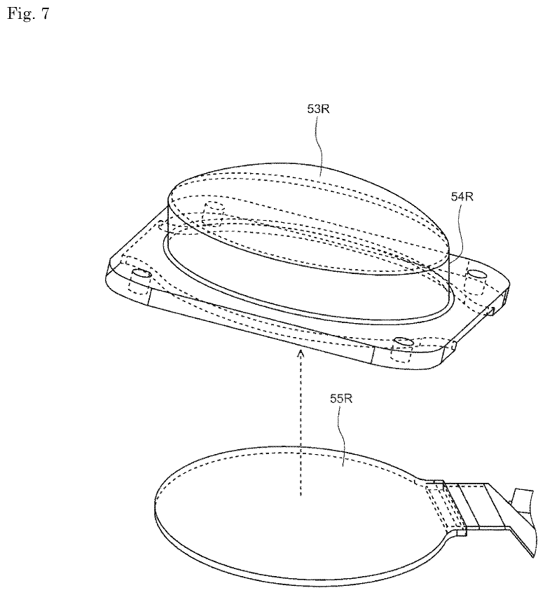

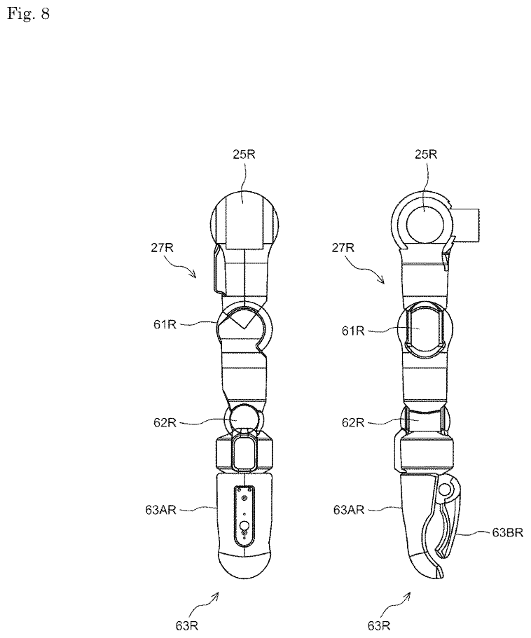

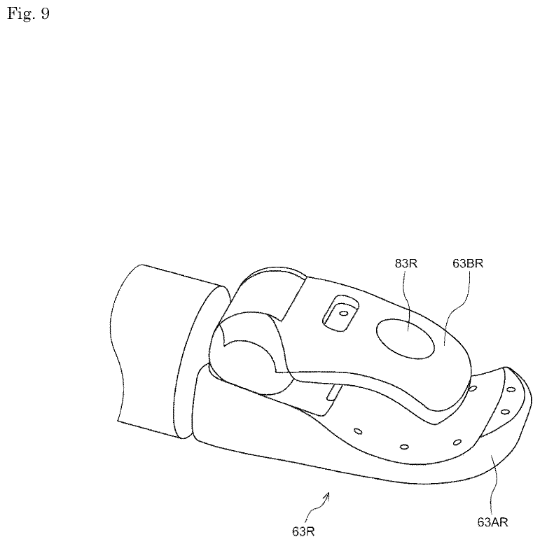

FIGS. 1 to 9 illustrate an example of the external appearance of the care robot 11. A in FIG. 1 is a front view of the care robot 11 in a normal posture. B in FIG. 1 is a left side view of the care robot 11 in the normal posture. FIG. 2 is a rear view of the care robot 11 in the normal posture. FIG. 3 is a perspective view of the care robot 11 in the normal posture, viewed from a right diagonal front direction. FIG. 4 is a perspective view of the care robot 11 in the normal posture, viewed from a left diagonal rear direction. FIG. 5 is a diagram comparing the care robot 11 with the size of a typical table 12. FIG. 6 is an enlarged view of a head part 21 of the care robot 11. FIG. 7 is an exploded view illustrating an example of the internal configuration of an eyeball part 41R of the care robot 11. FIG. 8 is an exterior view of an arm part 27R of the care robot 11. FIG. 9 is an exterior view of a hand 63R of the care robot 11.

Here, the normal posture is a posture in which a neck joint axis 24C of a neck 24 and a lumbar joint axis 26C of a waist 26 are not rotated, and the neck 24 and the waist 26 are in a substantially upright state.

The care robot 11 has an external appearance modeled after a child, for example, based on the concept of a “grandchild” robot.

The care robot 11 includes the head part 21, a torso part 22, and a base part 23, corresponding to the lower body, that supports the torso part 22. A truck 71 capable of omnidirectional movement is provided at a bottom of the base part 23. This enables the care robot 11 to move in all directions.

The care robot 11 includes an arm part 27L attached to an upper-left part of the torso part 22, and the arm part 27R attached to an upper-right part of the torso part 22.

The care robot 11 includes the mobile neck 24, which is provided between the head part 21 and the torso part 22, and which includes the neck joint axis 24C. The neck 24 has a cylindrical shape, which makes the boundary between the neck 24 and the neighboring parts clear, and makes it easier for a subject to view the neck 24 as a moving part and an axis of rotation. In particular, the neck 24 has a shape which is stepped along the yaw axis despite not actually moving along the yaw axis, which makes the boundary with the neighboring parts even clearer.

The care robot 11 includes a mobile shoulder 25L, which is provided between the torso part 22 and the arm part 27L and includes a shoulder joint axis 25LC, and a mobile shoulder 25R, which is provided between the torso part 22 and the arm part 27R and includes a shoulder joint axis 25RC. The shoulder 25L and the shoulder 25R have parts shaped like circles (called “circular parts” hereinafter) in accordance with the shoulder joint axis 25LC and the shoulder joint axis 25RC, which are mobile axes. A subject can easily predict the movement of the shoulder 25L and the shoulder 25R by imagining an axis of rotation extending from the center of each circular part.

Spherical parts serving as the moving parts of the shoulder 25L and the shoulder 25R are disposed so as to be embedded in (inserted into) respective sides of the torso part 22. This provides a sense of unity with and continuity from the torso part 22 to the arm part 27L and the arm part 27R.

When there is no need to distinguish between the shoulder 25L and the shoulder 25R individually, these will simply be referred to as “shoulders 25”. Likewise, when there is no need to distinguish between the shoulder joint axis 25LC and the shoulder joint axis 25RC individually, these will simply be referred to as “shoulder joint axes 25C”. Furthermore, when there is no need to distinguish between the arm part 27L and the arm part 27R individually, these will simply be referred to as “arm parts 27”.

The mobile waist 26, which includes the lumbar joint axis 26C, is provided in a lower part of the torso part 22. A spherical part rotated by the lumbar joint axis 26C (called a “lumbar axis rotation moving part” hereinafter) is formed at the lower end of the waist 26. A line on the side surface of the abdomen, between a chest outer part 105 (described later) of the torso part 22 and the waist 26, has a shape close to the tangent line of the spherical part serving as the lumbar axis rotation moving part. A line on the front surface of the abdomen may or may not have a shape close to the tangent line of the spherical part serving as the lumbar axis rotation moving part. A line on the rear surface of the abdomen has a shape close to the tangent line of the spherical part serving as the lumbar axis rotation moving part, and is connected to the lumbar axis rotation moving part with a large fillet shape. Accordingly, the lumbar axis rotation moving part (the spherical part) is mainly exposed in the front-back direction, and is substantially unexposed in the left-right direction.

The subject can easily predict the movement of the waist 26 by imagining an axis of rotation extending from the center of the lumbar axis rotation moving part. The lumbar axis rotation moving part covers the range of motion, which prevents fingers and the like from being pinched while the waist 26 moves.

The neck joint axis 24C, the shoulder joint axis 25C, and the lumbar joint axis 26C are offset in the front-back direction. Specifically, when the care robot 11 in the normal posture is viewed from the side, the neck joint axis 24C is offset to the rear with respect to the shoulder joint axis 25C, and the lumbar joint axis 26C is offset to the front with respect to the shoulder joint axis 25C. This gives the care robot 11 a natural appearance when in a standing posture.

In addition to the truck 71 mentioned above, the base part 23 includes a base outer part 72.

The base outer part 72 has a design reminiscent of an apron or a smock, and has a shape similar to a thick conical frustum that expands with proximity to the ground. When the care robot 11 is viewed from the front, the torso part 22 and the base outer part 72 connect naturally, with the silhouette of the base outer part 72 expanding with proximity to the ground. This provides a sense of stability without imparting a sense of unnaturalness on the subject.

The range of motion of the waist 26 is set to the minimum necessary range, and the lumbar joint axis 26C, which is the rotational center of the waist 26, is embedded in the base outer part 72. In other words, the lumbar axis rotation moving part is inserted into the base outer part 72, and the periphery thereof is surrounded by the base outer part 72.

This reduces the area where the moving part of the waist 26 (the lumbar axis rotation moving part) is exposed to the outside, and reduces movement of the part of the waist 26 visible to the subject, which can provide the subject with a sense of stability and security.

A gap of a width which is substantially constant over 360 degrees is provided between the torso part 22 and the base outer part 72. The width of the gap remains substantially constant without changing even when the waist 26 (the lumbar axis rotation moving part) rotates, which protects against imparting a sense of anxiousness on the subject, e.g., that their finger or the like will be pinched.

A gap (an opening) extending 360 degrees is provided between the base outer part 72 and the truck 71 such that distances can be measured in all directions. When the care robot 11 is viewed from above looking downward, the diameter of the upper surface of the truck 71 is slightly smaller than the diameter of the lower surface of the base outer part 72, to the extent that the area where the upper surface of the truck 71 can be seen through the gap is reduced. On the other hand, the lower part of the truck 71 is provided with bumper sensors in all directions, and therefore has a shape that protrudes slightly compared to the upper part.

The base outer part 72 and the truck 71 are connected by four pillars. Each pillar is disposed so as to be as thin as possible and as close to the center of the base part 23 as possible. This makes each pillar invisible when the care robot 11 is viewed looking downward from above. Additionally, the surface of each pillar is set to be a mirror surface or a dark matte color so as to be inconspicuous. Wiring is routed through the inside of each pillar.

A maintenance hatch 73L and a maintenance hatch 73R, which open downward, are provided on the left and right sides of the base outer part 72. A maintenance hatch 73B is provided on the rear surface of the base outer part 72. An emergency stop switch 74 for stopping the care robot 11 in an emergency is provided above the maintenance hatch 73B.

Hereinafter, when there is no need to distinguish between the maintenance hatch 73L, the maintenance hatch 73R, and the maintenance hatch 73B individually, these will simply be referred to as “maintenance hatches 73”.

Each maintenance hatch 73 has a round shape that resembles a garment pattern, which gives the subject the impression of an apron and pockets, for example.

Each maintenance hatch 73 is secured to the base outer part 72 by a magnet, and can be opened and closed without using tools. Opening each maintenance hatch 73 provides access to a battery and an internal personal computer (PC) built into the care robot 11. Opening the maintenance hatch 73L and the maintenance hatch 73R also provides handles on both sides of the care robot 11, and the care robot 11 can therefore easily be lifted using the handles.

Flexible materials, such as elastomers, are used for the maintenance hatch 73L and the maintenance hatch 73R, for example. Accordingly, when the base part 23 and the arm parts 27 interfere with each other, the interfering part can be prevented from being damaged or malfunctioning. When the care robot 11 is powered off, the arms 27 cease being powered and are lowered, and thus the parts where the maintenance hatch 73L and the maintenance hatch 73R are provided are prone to interference with the arms 27.

The height of the care robot 11 is a height at which the robot can be looked somewhat down upon by a subject who is in a seated posture while sitting on a chair. The height of the care robot 11 is a height at which the robot can overlook a typical table 12, as illustrated in FIG. 5.

As illustrated in FIG. 6, the head part 21 includes an eyeball part 41L and an eyeball part 41R. The eyeball part 41L includes an eye white part 51L and a pupil part 52L provided within the eye white part 51L. The eye white part 51L is cut in an oblique direction, which improves the visibility of the pupil part 52R from the lateral direction.

Like the eyeball part 41L, the eyeball part 41R includes an eye white part 51R and a pupil part 52R provided within the eye white part 51R.

As illustrated in FIG. 7, the eyeball part 41R includes a transparent solid cylindrical part 54R having a first end surface and a second end surface. The eyeball part 41R is provided on the first end surface side (the lower side, in FIG. 7) of the cylindrical part 54R, and includes a planar eyeball display 55R that displays movement of the pupil part 52R. The eyeball part 41 is provided on the second end surface side (the upper side, in FIG. 7) of the cylindrical part 54R, and includes a transparent spherical part 53R, which has a hemisphere shape and which emits display light from the eyeball display 55R incident through the cylindrical part 54R. The spherical part 53R constitutes a transparent spherical lens having a hemisphere shape. The outer peripheral shape of the spherical part 53R is configured to be the eye white part 51R.

The outer circumferential surface of the cylindrical part 54R is opaque to prevent light from entering, and images displayed in the eyeball display 55R, which can be seen from the spherical part 53R, are therefore clear and lack distortion. Additionally, the spherical part 53R is disposed with a gap between the spherical part 53R and the eyeball display 55R, which provides a sense of three-dimensional depth. The sphere center of the spherical part 53R is designed as the virtual rotational center of the eyeball, and movement of the pupil part 52R displayed in the eyeball display 55R is controlled on the basis of the sphere center of the spherical part 53R.

As described above, unlike a flat display, the eyeball part 42R is displayed in a built-in sphere having good visibility from any angle, or appears to be moving, without distortion, which makes it possible to recreate the likeness of an actual eyeball. The center of the pupil part 52R and the center of the sphere of the spherical part 53R are aligned, which eliminates a sense of unnaturalness in terms of the thickness and shape of the sphere. Furthermore, by showing reflected light produced by ambient light on the surface of the spherical part 53R, highlights of the pupil are expressed naturally and in real time.

Although not illustrated, the eyeball part 41L also includes a spherical part 53L, a cylindrical part 54L, and an eyeball display 55L, and is configured to be horizontally symmetrical with the eyeball part 41R.

The care robot 11 performs human recognition and facial recognition using, for example, a head sensor 81, and gazes at the subject by controlling the position of the pupil part 52L of the eyeball part 41L, the position of the pupil part 52R of the eyeball part 41R, and the axes (roll, pitch, and yaw) of the neck 24. Specifically, the subject is gazed upon by the pupil part 52L and the pupil part 52R following the position of the subject in the up, down, left, and right directions. The distance from the subject is also expressed using an angle of convergence between the pupil part 52L and the pupil part 52R (a convergent gaze or a divergent gaze). This makes it easier for the subject to recognize the direction in which the care robot 11 is gazing (especially in a depth direction).

Hereinafter, when there is no need to distinguish between the eyeball part 41L and the eyeball part 41R individually, these will simply be referred to as “eyeball parts 41”. When there is no need to distinguish between the eye white part 51L and the eye white part 51R individually, these will simply be referred to as “eye white parts 51”. When there is no need to distinguish between the pupil part 52L and the pupil part 52R individually, these will simply be referred to as “pupil parts 52”. When there is no need to distinguish between the spherical part 53L and the spherical part 53R individually, these will simply be referred to as “spherical parts 53”. When there is no need to distinguish between the cylindrical part 54L and the cylindrical part 54R individually, these will simply be referred to as “cylindrical parts 54”. When there is no need to distinguish between the eyeball display 55L and the eyeball display 55R individually, these will simply be referred to as “eyeball displays 55”.

As illustrated in FIG. 8, the arm part 27R includes an elbow part 61R, a wrist 62R, and the hand 63R.

The elbow part 61R includes a pitch axis. The elbow part 61R includes a part shaped like a cylinder (called a “cylindrical part” hereinafter) in accordance with the pitch axis, which is a mobile axis. The subject can easily predict the movement of the elbow part 61R by imagining an axis of rotation extending from the center of the cylindrical part. Additionally, the cylindrical part covers the range of motion, which prevents fingers and the like from being pinched while the elbow part 61R moves.

The wrist 62R includes a yaw axis. The wrist 62R includes a part shaped like a cylinder (called a “cylindrical part” hereinafter) in accordance with the yaw axis, which is a mobile axis. The subject can easily predict the movement of the wrist 62R by imagining an axis of rotation extending from the center of the cylindrical part. Additionally, the cylindrical part covers the range of motion, which prevents fingers and the like from being pinched while the wrist 62R moves.

The hand 63R includes a part 63AR corresponding to a part other than the thumb and a part 63BR corresponding to the thumb. The part 63BR is opposite the part 63AR, and the hand 63R is capable of gripping objects when the part 63BR moves.

For the part 63AR, a flexible material such as an elastomer may be used, or a highly rigid resin may be used. Using a flexible material improves the safety of the hand 63R when coming into contact with the environment or people, for example. Additionally, for example, the part 63AR may be subjected to an antiviral or antimicrobial treatment, or an antiviral or antimicrobial material may be used.

Although not illustrated, the arm part 27L is configured in the same manner as the arm part 27R, and includes an elbow part 61L, a wrist 62L, and a hand 63L. Also, like the hand 63R, the hand 63L includes a part 63AL and a part 63BL.

Hereinafter, when there is no need to distinguish between the elbow part 61L and the elbow part 61R individually, these will simply be referred to as “elbow parts 61”. When there is no need to distinguish between the wrist 62L and the wrist 62R individually, these will simply be referred to as “wrists 62”. When there is no need to distinguish between the hand 63L and the hand 63R individually, these will simply be referred to as “hands 63”.

The head sensor 81 is provided in a front-upper part of the head part 21. The head sensor 81 includes, for example, a range image sensor, a microphone, a Light Detection and Ranging (LiDAR), or the like.

The head sensor 81 is configured such that the sensing direction is approximately the same direction as the gaze direction of the care robot 11, to enable the execution of humanitude motion, facial tracking motion, and the like.

For example, the care robot 11 is capable of human recognition and facial recognition using the head sensor 81, and can perform interactions in which the eyes of the subject are tracked.

Here, the height of a typical table 12 is, for example, about 700 mm, whereas the height of a typical table 12 in a care facility is, for example, about 660 mm. For example, as illustrated in FIG. 5, the head sensor 81 is disposed in a position at which the entire top surface 12A of the table 12 can be seen. The head part 21 is disposed in a position such that the robot looks up at the face of the subject who is sitting on a chair 13 (in a seated posture). The head sensor 81 is disposed at a position high on the head part 21 (e.g., at a height of about 760 mm), facing upward at an angle of about 5 degrees, for example. The head sensor 81 is also disposed so as not to protrude too much from the outer diameter line of the head part 21.

This enables the care robot 11 to recognize objects on a standard table 12 and to recognize the face of a subject in the seated posture on the other side of the table 12, for example, as illustrated in FIG. 5. The care robot 11 can recognize the face of a subject in the seated posture on a standard bed, and the face of a subject in a supine posture on a standard bed. The care robot 11 is capable of facial recognition when looking up, at an angle, at a subject in the seated posture at close range, facial recognition when looking up, at an angle, at a subject in a standing posture at close range, and the like.

A chest sensor 82 is provided in a front-upper part of the torso part 22 (the chest area). The chest sensor 82 includes, for example, a non-contact vital sign sensor or the like. A sensor that measures body temperature, heartbeat, respiratory rate, oxygen saturation level, blood pressure, or the like is used as the non-contact vital sign sensor.

The chest sensor 82 is installed at a position in the front-upper part of the torso part 22 (e.g., at a height of about 537 mm), facing upward at an angle of about 10 degrees, for example. This enables the chest sensor 82 to take measurements without being affected by the motion of the head part 21. The chest sensor 82 can reduce the occurrence of blind spots by the arm parts 27 during manipulation. The chest sensor 82 enables the sensing of vital signs from the face of a subject in the seated posture, the face of a subject in the standing posture at a distance (e.g., about 2 m), the face of a subject in the supine posture at a distance, and the like. The chest sensor 82 is capable of sensing changes in the state of the subject continually while applications are being executed.

A hand sensor 83R is provided in the hand 63R. The hand sensor 83R includes, for example, a contact-type vital sign sensor or the like. The contact-type vital sign sensor includes, for example, a heartbeat sensor, a blood pressure sensor, an oxygen saturation level measurement sensor, and the like.

The hand sensor 83R is disposed on an outer side of the part 63BR of the hand 63R, for example, as illustrated in FIG. 9. This prevents the hand 63R from pinching the subject's hand when sensing vital signs.

The hand sensor 83R also enables sensing of vital signs by having the subject place their hand on or hold the robot's hand, rather than having the care robot 11 itself travel to the subject to bring the subject into contact with the hand sensor 83R. This is an interface which is familiar to people with dementia, and one which subjects are receptive to. It is also possible to separately provide a sensor or the like inside of the hand 63R to control the gripping force thereof.

Although not illustrated here, a hand sensor 83L, which includes a vital sign sensor similar to that of the hand sensor 83R, is provided on the outer side of the part 63BL of the hand 63L.

Hereinafter, when there is no need to distinguish between the hand sensor 83L and the hand sensor 83R individually, these will simply be referred to as “hand sensors 83”.

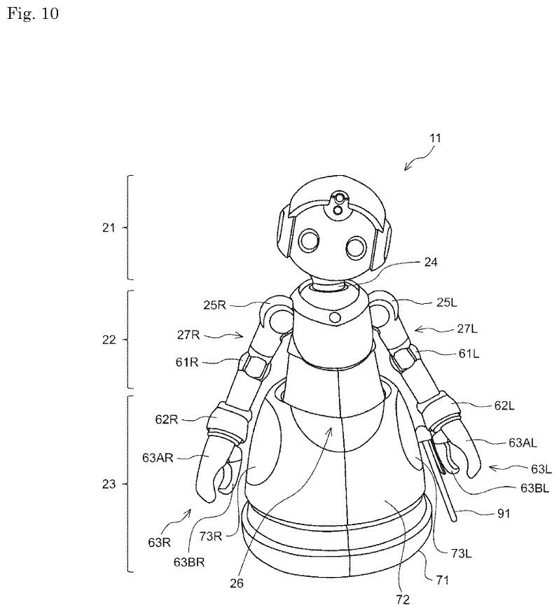

As illustrated in FIGS. 10 to 12, a hand display 91 can be attached to the hand 63L of the care robot 11. The hand display 91 includes an 8-inch display unit, for example. The hand display 91 is attached to the outer side of the part 63BL of the hand 63L, for example, such that the longitudinal direction of the hand display 91 coincides with the direction in which the arm part 27L extends. This makes it difficult for the hand display 91 to interfere with other parts of the care robot 11, and improves visibility for the user.

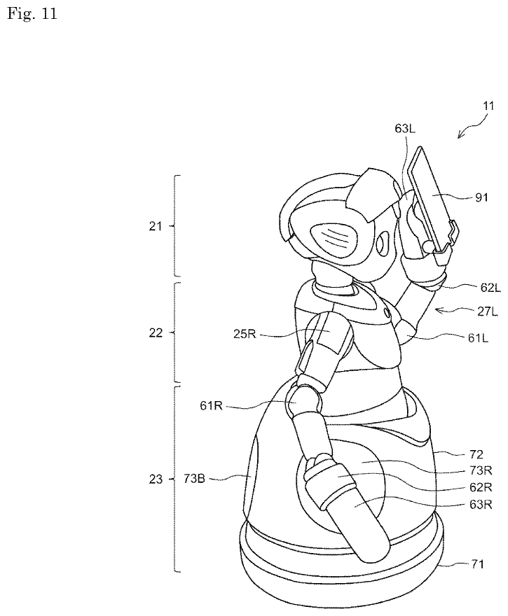

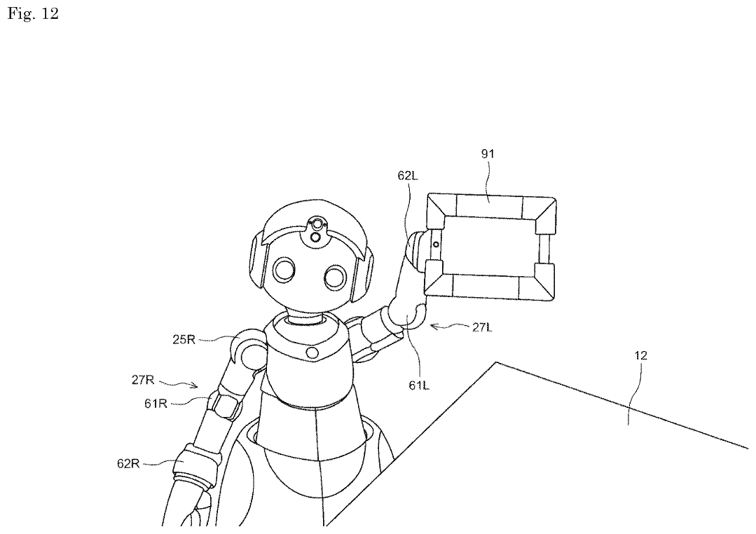

For example, as illustrated in FIGS. 11 and 12, the care robot 11 controls the mobile axis of the arm part 27L to control tracking such that the screen of the hand display 91 faces in the direction of the head of the subject. This makes it possible to move the hand display 91 to a position easily visible to the subject regardless of the subject's seated posture.

Although not illustrated here, a hand display 91 can also be attached to the hand 63R of the care robot 11.

Additionally, for example, a handle-type grip part may be provided on the rear surface of the hand display 91, such that the care robot 11 grips the hand display 91 with the hand 63L or the hand 63R.

As described above, the care robot 11 provides a sense of realism, equivalent to a child aged 2 to 3 years old, and is a moderately small size that can be looked down upon by an elderly person who is sitting. The care robot 11 has a shape in which the head is large, and therefore resembles a cute grandchild. The eyeball part 41 is disposed at a height where it is easy for the subject to meet the robot's gaze, which makes it easy for the subject to recognize the gaze and images displayed in the eyeball part 41. The care robot 11 does not have axes of freedom or a range of motion different from a person, which makes the actions thereof natural, and it is easy for the subject to understand the movement of the care robot 11.

The configuration is such that the head part 21 is disposed at a height at which the entire top of the typical table 12 can be seen, and the height of the shoulders 25 and the length of the arm parts 27 make it possible to approach the end of the table 12.

This makes it easy for subjects to be receptive to the care robot 11 without imparting a sense of intimidation or fear. The care robot 11 can also execute humanitude motions or basic applications used in an active monitoring robot, for example.

### <Other Exterior Features>

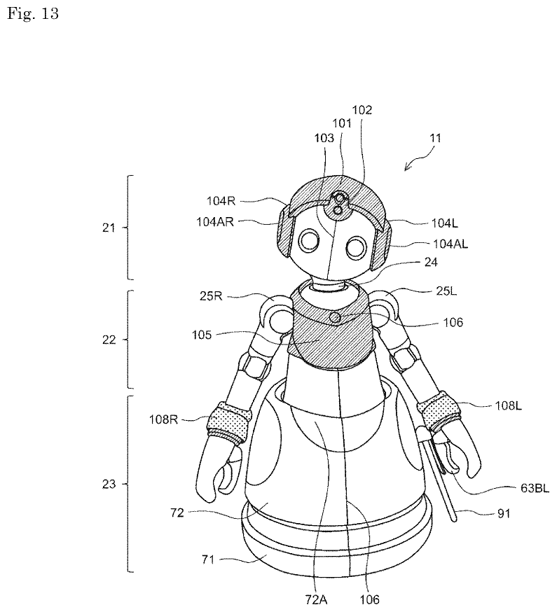

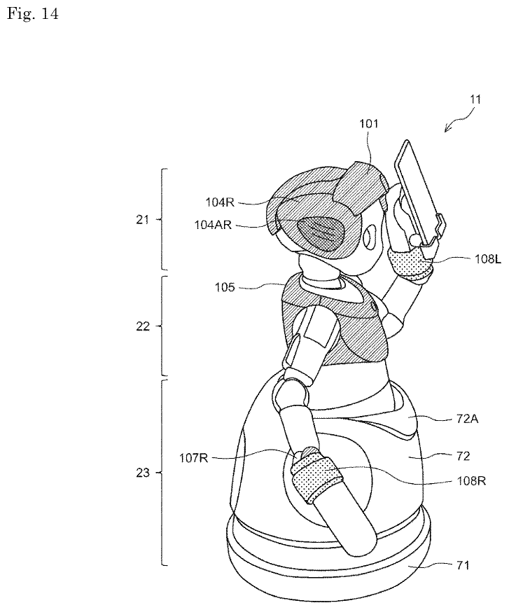

Features of the external appearance of the care robot 11 other than those described above will be described next with reference to FIGS. 13 and 14.

The base color of the care robot 11 is set to white (a bright white), and as will be described later, the color of some parts of the exterior is set to brown (a soft, gentle, cute, dark brown) or the like. This increases the contrast of the colors throughout the body. In FIGS. 13 and 14, parts other than those having white as the base are indicated by hatching.

A head outer part 101 is provided on a top part of the head of the care robot 11. The head outer part 101 has a design reminiscent of a hat, a hair band, or hair, for example. A side surface and a rear head part of the head outer part 101 also have a design reminiscent of a nurse's cap. The head outer part 101 is set to a position easy for the subject to stroke, and to a shape and color (e.g., brown) easy for the subject to stroke. The head outer part 101 is warm to the touch due to heat generated by the head sensor 81 provided therein.

The head outer part 101 is secured by a claw-shaped part and a single screw, is removable, and is easy to maintain. For example, an opening of a part exposed when the head outer part 101 is removed is large, allowing access to a circuit board or the like built into the care robot 11.

An external frame part 102 is provided around a window for the head sensor 81 of the care robot 11. The external frame part 102 has a shape similar to that of an accessory. The window of the head sensor 81 is a semi-transparent black color, and thus the external frame part 102 is set to a dark color, e.g., a color similar to that of the head outer part 101 (e.g., brown), so as to reduce the contrast and obscure the boundary.

A baby schema is adopted for the parameters of the face of the care robot 11. The mouth of the care robot 11 has a stylized shape. A ridge line 103 representing the nose and mouth is formed in the center of the face of the care robot 11. A shadow cast by the ridge line 103 makes it easier for the subject to recognize the orientation of the face.

An ear part 104L corresponding to the left ear is provided on the left side surface of the face of the care robot 11. The ear part 104L has a large ear shape to enables subjects to recognize the side surface of the face. The ear part 104L is shaped with the front thereof larger, and appears to flow in the rearward direction, to make it easier to understand the front-back direction of the ear.

A central part 104AL of the ear part 104L is the same shape as the ear part 104L but slightly smaller, and is set to a different color from the periphery (e.g., red). Three long, thin, whisker-shaped holes extending in the front-back direction are formed in the central part 104AL. These whisker-shaped holes make it easier for the subject to recognize the front-back direction of the face of the care robot 11. The whisker-shaped holes also provide effects such as collecting sound for a microphone built into the care robot 11, dissipating heat from the circuit board, and the like, as well as enhancing the design.

The chest outer part 105 is provided in an upper part of the torso part 22 of the care robot 11 (the chest area). Both shoulders 25 have a shape slightly reminiscent of a puff sleeve. A garment-like design is achieved by the chest outer part 105 and the shoulders 25. The color of the chest outer part 105 is set to a color similar to that of the head outer part 101 and the external frame part 102, for example (e.g., brown). On the other hand, the shoulders 25 are set to white such that the shoulder width does not seem large. A window of the chest sensor 82 is disposed in a position at which the window appears to be a button of the garment which the chest outer part 105 resembles, so as not to impart a sense of unnaturalness on the subject.

This prevents the care robot 11 from appearing naked. The contrast achieved by the shape and color also makes the boundary between the torso part 22 and the moving parts, i.e., the neck 24 and the arm parts 27, clear.

A gap of a width which is substantially constant over 360 degrees is provided between the chest outer part 105 and the abdomen, and sound from a speaker built into the care robot 11 is output through this gap to the outside of the body.

A parting line 106 extending in the vertical direction from directly below the chest outer part 105 to a lower end is formed in the front-center of the care robot 11. The parting line 106 is formed by arranging, in the vertical direction, parabolic U-shaped lines having inflection points in the front-center of the care robot 11. The parting line 106 makes it easier for the subject to recognize the front of the care robot 11. Note that the parting line 106 does not necessarily have to be provided.

A U-shaped protruding part 72A is formed in the front and near the upper end of the base outer part 72. The protruding part 72A has a design reminiscent of a pocket in an apron, for example. The parabolic shape of the protruding part 72A makes it easier for the subject to recognize the center of the front of the care robot 11. The protruding part 72A extends further outward from the periphery by about 10 to 20 mm, for example, and functions as a screen that reduces the exposure of the lumbar axis rotation moving part, similar to the eaves of a roof. This suppresses situations where the subject becomes unnerved by the movement of the lumbar axis rotation moving part.

For example, making the protruding part 72A a movable shutter structure makes it possible to expand the range of flexion of the waist 26 in the forward direction.

A wrist outer part 107L is formed in the wrist 62L. The color of the wrist outer part 107L is set to a color similar to that of the head outer part 101, for example (e.g., brown).

A fabric wristband 108L is attached to the outer periphery of the wrist outer part 107L. The color of the wristband 108L is set to a different color in the same color range as the wrist outer part 107L (e.g., burgundy).

The wrist outer part 107L and the wristband 108L clarify the boundary between the hand 63L and the other parts of the arm part 27L, and improve the visibility of the hand 63L. The wristband 108L also prevents scratches produced by contact between the wrist 62L and the base outer part 72. The wristband 108L also improves the safety when the wrist 62L comes into contact with people or the surrounding environment.

Note that the wrist 62R is also provided with a wrist outer part 107R and a wristband 108R, in the same manner as the wrist 62L.

The care robot 11 can also be dressed in children's clothes.

### <Examples of Design Values of Parts>

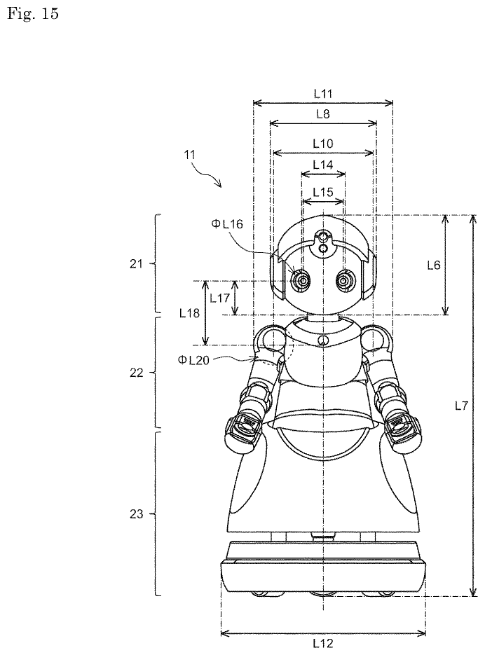

Examples of the design value of each part of the care robot 11 in the normal posture will be described next with reference to FIGS. 15 to 22.

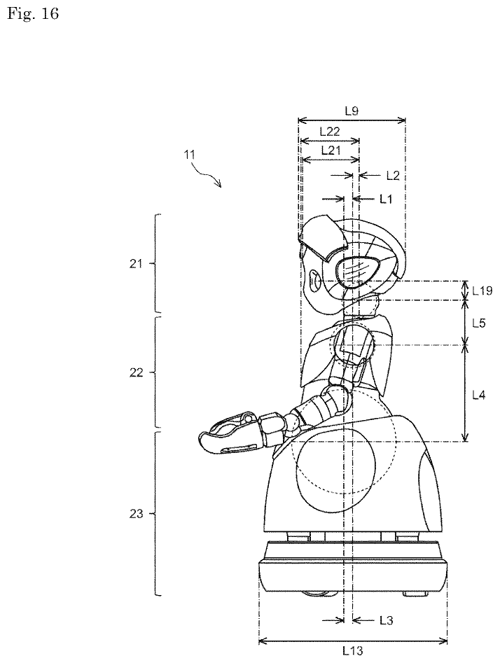

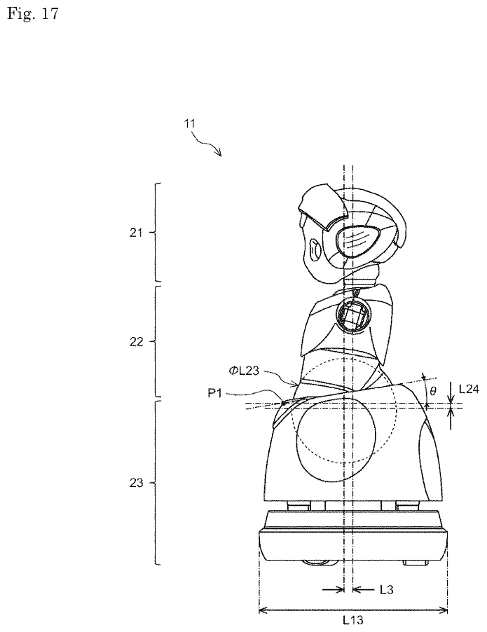

FIG. 15 is a front view illustrating positions of dimensions of each part of the care robot 11. FIG. 16 is a left side view illustrating positions of dimensions of each part of the care robot 11. FIG. 17 is a left side view illustrating positions of dimensions of each part of the care robot 11, with the arm part 27L thereof not shown.

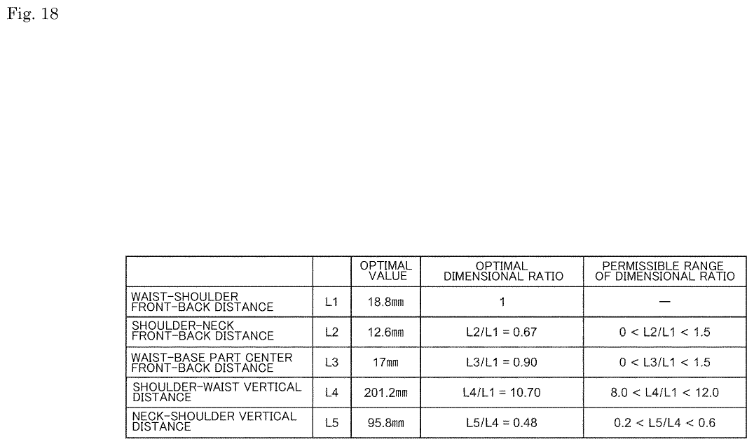

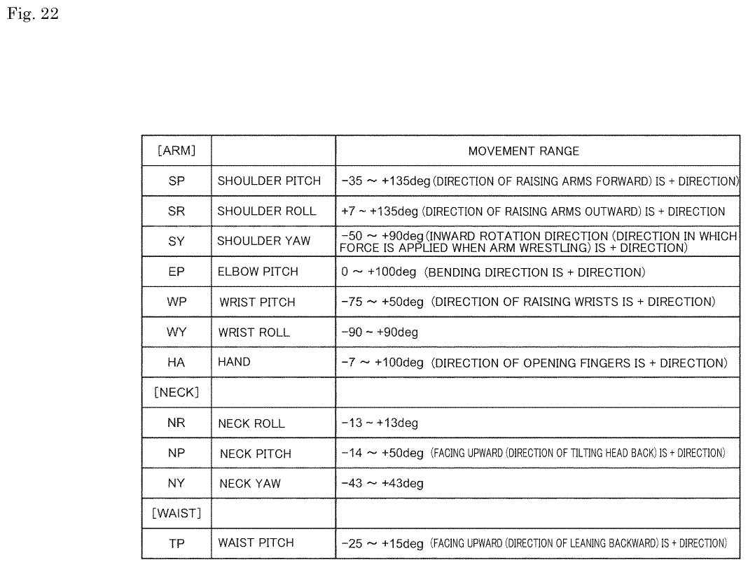

FIGS. 18 to 21 illustrate an example of optimal values for the dimensions of the parts of the care robot 11, optimal dimensional ratios, and permissible ranges for the dimensional ratios. FIG. 22 illustrates an example of the movement range of each joint axis of the care robot 11. Note that the specific numerical values in FIGS. 18 to 22 are merely examples, and other numerical values may be used.

Note also that FIGS. 18 to 21 illustrate distances in the front-back direction (the depth direction), with the direction from the front to the back serving as the positive direction. The distance in the vertical direction (the height direction) is indicated with the direction from the top to the bottom serving as the positive direction.

A distance L1 is a distance between the waist 26 and the shoulders 25 in the front-back direction (an offset distance), and specifically is a distance between the lumbar joint axis 26C and the shoulder joint axis 25C in the front-back direction. The optimal value for the distance L1 is 18.8 mm.

A distance L2 is a distance between the shoulders 25 and the neck 24 in the front-back direction (an offset distance), and specifically is a distance between the shoulder joint axis 25C and the neck joint axis 24C in the front-back direction. The optimal value for the distance L2 is 12.6 mm. The optimal value for the dimensional ratio of the distance L2 to the distance L1 is 0.67. The following Formula (1) indicates a permissible range for the dimensional ratio of the distance L2 to the distance L1.

$$0 < L 2 / L 1 < 1.5 \qquad ( 1 )$$

A distance L3 is a distance between the waist 26 and the center of the base part 23 in the front-back direction, and specifically is a distance between the lumbar joint axis 26C and the front-back direction center of the base part 23 in the front-back direction. The optimal value for the distance L3 is 17 mm. The optimal value for the dimensional ratio of the distance L3 to the distance L1 is 0.90. The following Formula (2) indicates a permissible range for the dimensional ratio of the distance L3 to the distance L1.

$$0 < L 3 / L 1 < 1.5 \qquad ( 2 )$$

A distance L4 is a distance between the shoulders 25 and the waist 26 in the vertical direction, and specifically is a distance between the shoulder joint axis 25C and the lumbar joint axis 26C in the vertical direction. The optimal value for the distance L4 is 201.2 mm. The optimal value for the dimensional ratio of the distance L4 to the distance L1 is 10.70. The following Formula (3) indicates a permissible range for the dimensional ratio of the distance L4 to the distance L1.

$$8. < L 4 / L 1 < 1 2. \qquad ( 3 )$$

A distance L5 is a distance between the neck 24 and the shoulders 25 in the vertical direction, and specifically is a distance between the neck joint axis 24C and the shoulder joint axis 25C in the vertical direction. The optimal value for the distance L5 is 95.8 mm. The optimal value for the dimensional ratio of the distance L5 to the distance L4 is 0.48. The following Formula (4) indicates a permissible range for the dimensional ratio of the distance L5 to the distance L4.

$$0.2 < L 5 / L 4 < 0.6 \qquad ( 4 )$$

A distance L6 is the height (the length in the vertical direction) of the head part 21. The optimal value for the distance L6 is 212 mm.

The optimal value for the dimensional ratio of the distance L5 to the distance L6 is 0.45. The following Formula (5) indicates a permissible range for the dimensional ratio of the distance L5 to the distance L6.

$$0.3 < L 5 / L 6 < 0.6 \qquad ( 5 )$$

A distance L7 is the height. The optimal value for the distance L7 is 812 mm. The optimal value for the dimensional ratio of the distance L7 to the distance L6 is 3.83. The following Formula (6) indicates a permissible range for the dimensional ratio of the distance L7 to the distance L6.

$$3.3 < L 7 / L 6 < 5. \qquad ( 6 )$$

A distance L8 is the width (the length in the left-right direction) of the head part 21. The optimal value for the distance L8 is 225 mm. The optimal value for the dimensional ratio of the distance L8 to the distance L6 is 1.06. The following Formula (7) indicates a permissible range for the dimensional ratio of the distance L8 to the distance L6.

$$1. \leq L 8 / L 6 < 1.3 \qquad ( 7 )$$

A distance L9 is the depth (the length in the front-back direction) of the head part 21. The optimal value for the distance L9 is 228 mm. The optimal value for the dimensional ratio of the distance L9 to the distance L6 is 1.08. The following Formula (8) indicates a permissible range for the dimensional ratio of the distance L9 to the distance L6.

$$1. \leq L 9 / L 6 < 1.5 \qquad ( 8 )$$

A distance L10 is a distance between the shoulder joints, and specifically is a distance between the shoulder joint axis 25LC and the shoulder joint axis 25RC in the left-right direction. The optimal value for the distance L10 is 212 mm. The optimal value for the dimensional ratio of the distance L10 to the distance L6 is 1.00. The following Formula (9) indicates a permissible range for the dimensional ratio of the distance L10 to the distance L6.

$$0.8 < L 10 / L 6 < 1.2 \qquad ( 9 )$$

A distance L11 is the shoulder width. The optimal value for the distance L11 is 296 mm. The optimal value for the dimensional ratio of the distance L11 to the distance L6 is 1.40. The following Formula (10) indicates a permissible range for the dimensional ratio of the distance L11 to the distance L6.

$$1.2 < L 11 / L 6 < 1.6 \qquad ( 10 )$$

A distance L12 is the width (the length in the left-right direction) of the base part 23. The optimal value for the distance L12 is 433 mm. The optimal value for the dimensional ratio of the distance L12 to the distance L6 is 2.04. The following Formula (11) indicates a permissible range for the dimensional ratio of the distance L12 to the distance L6.

$$1.5 < L 12 / L 6 < 2.5 \qquad ( 11 )$$

A distance L13 is the depth (the length in the front-back direction) of the base part 23. The optimal value for the distance L13 is 400 mm. The optimal value for the dimensional ratio of the distance L13 to the distance L6 is 1.89. The following Formula (12) indicates a permissible range for the dimensional ratio of the distance L13 to the distance L6.

$$1.5 < L 13 / L 6 < 2.5 \qquad ( 12 )$$

A distance L14 is a distance between the eyeball parts, and specifically is a distance between the center of the eyeball part 41L and the center of the eyeball part 41R in the left-right direction. The optimal value for the distance L14 is 93 mm. The optimal value for the dimensional ratio of the distance L14 to the distance L6 is 0.44. The following Formula (13) indicates a permissible range for the dimensional ratio of the distance L14 to the distance L6.

$$0.35 < L 14 / L 6 < 0 \text{.55} \qquad ( 13 )$$

A distance L15 is a distance between the pupil parts, and specifically is a distance between the center of the pupil part 52L and the center of the pupil part 52R in the left-right direction. The optimal value for the distance L15 is 85 mm. The optimal value for the dimensional ratio of the distance L15 to the distance L14 is 0.91. The following Formula (14) indicates a permissible range for the dimensional ratio of the distance L15 to the distance L14.

$$0.8 < L 15 / L 14 < 1. \qquad ( 14 )$$

A distance L16 is the diameter of the circumference of the eyeball part 41. The optimal value for the distance L16 is 34 mm. The optimal value for the dimensional ratio of the distance L16 to the distance L14 is 0.37. The following Formula (15) indicates a permissible range for the dimensional ratio of the distance L16 to the distance L14.

$$0.3 < L 16 / L 14 < 0.5 \qquad ( 15 )$$

A distance L17 is a distance between the eyeball parts 41 and the chin in the vertical direction, and specifically is a distance between the center of the eyeball parts 41 and the lower end of the head part 21 in the vertical direction. The optimal value for the distance L17 is 72.8 mm. The optimal value for the dimensional ratio of the distance L17 to the distance L6 is 0.34. The following Formula (16) indicates a permissible range for the dimensional ratio of the distance L17 to the distance L6.

$$0.2 < L 17 / L 6 < 0.5 \qquad ( 16 )$$

A distance L18 is a distance between the eyeball parts 41 and the shoulders 25 in the vertical direction, and specifically is a distance between the center of the eyeball parts 41 and the shoulder joint axis 25C in the vertical direction. The optimal value for the distance L18 is 137.3 mm. The optimal value for the dimensional ratio of the distance L18 to the distance L17 is 1.89. The following Formula (17) indicates a permissible range for the dimensional ratio of the distance L18 to the distance L17.

$$1.3 < L 18 / L 17 < 2.5 \qquad ( 17 )$$

A distance L19 is a distance between the eyeball parts 41 and the neck 24 in the vertical direction, and specifically is a distance between the center of the eyeball parts 41 and the neck joint axis 24C in the vertical direction. The optimal value for the distance L19 is 41.6 mm. The optimal value for the dimensional ratio of the distance L19 to the distance L17 is 0.57. The following Formula (18) indicates a permissible range for the dimensional ratio of the distance L19 to the distance L17.

$$0.4 < L 19 / L 17 \leq 1. \qquad ( 18 )$$

A distance L20 is the diameter of the shoulder joint. The optimal value for the distance L20 is 84 mm. The optimal value for the dimensional ratio of the distance L20 to the distance L17 is 1.15. The following Formula (19) indicates a permissible range for the dimensional ratio of the distance L20 to the distance L17.

$$0.7 < L 20 / L 17 < 1.5 \qquad ( 19 )$$

A distance L21 is a distance between the face and the neck 24 in the front-back direction, and specifically is a distance between a front end of the head part 21 and the neck joint axis 24C in the front-back direction. The optimal value for the distance L21 is 120.9 mm. The optimal value for the dimensional ratio of the distance L21 to the distance L17 is 1.66. The following Formula (20) indicates a permissible range for the dimensional ratio of the distance L21 to the distance L17.

$$1.4 < L 21 / L 17 < 1.8 \qquad ( 20 )$$

A distance L22 is a distance between a front end of the torso part 22 and the neck 24, and specifically is a distance between the front end of the torso part 22 and the neck joint axis 24C in the front-back direction. The optimal value for the distance L22 is 124.4 mm. The optimal value for the dimensional ratio of the distance L22 to the distance L17 is 1.71. The following Formula (21) indicates a permissible range for the dimensional ratio of the distance L22 to the distance L17.

$$1.4 < L 22 / L 17 < 1.8 \qquad ( 21 )$$

Additionally, the optimal value for the dimensional ratio of the distance L22 to the distance L21 is 1.03. The following Formula (22) indicates a permissible range for the dimensional ratio of the distance L22 to the distance L21.

$$1. < L 22 / L 21 < 1.3 \qquad ( 22 )$$

A distance L23 is the diameter of the lumbar axis rotation moving part. The optimal value for the distance L23 is 222 mm. The optimal value for the dimensional ratio of the distance L3 to the distance L23 is 0.08. The following Formula (23) indicates a permissible range for the dimensional ratio of the distance L3 to the distance L23.

$$0 < L 3 / L 23 < 0.4 \qquad ( 23 )$$

The optimal value for the dimensional ratio of the distance L13 to the distance L23 is 1.8. The following Formula (24) indicates a permissible range for the dimensional ratio of the distance L3 to the distance L23.

$$1. < L 13 / L 23 < 2.5 \qquad ( 24 )$$

A distance L24 is a distance between a front end reference position P1 of the base outer part 72 and the waist 26 in the vertical direction, and specifically is a distance between the front end reference position P1 and the lumbar joint axis 26C in the vertical direction. The front end reference position P1 is a point of intersection between an auxiliary line indicating an inclination of an inclined part of the upper end of the base outer part 72 and (the front end of the base outer part 72, when viewed from the side. The inclined part of the upper end of the base outer part 72 is inclined at an upward angle from the front to the back, and the front end reference position P1 is in a position higher than the lumbar joint axis 26C. The optimal value for the distance L24 is 10.5 mm. The optimal value for the ratio of the distance L24 to the distance L23 is 0.05. The following Formula (25) indicates a permissible range for the dimensional ratio of the distance L24 to the distance L23.

$$0 < L 24 / L 23 < 0.4 \qquad ( 25 )$$

An angle θ is the angle of inclination of the inclined part of the upper end of the base outer part 72 (the angle relative to a plane on which the care robot 11 is standing (i.e., a floor), when viewed from the side. The optimal value for the angle θ is 9 degrees. The following Formula (26) indicates a permissible range for the angle θ.

$$0 degrees < θ < 30 degrees \qquad ( 26 )$$

A movement range SP of the shoulders 25 (the shoulder joint axis 25C) in the pitch direction is from −35 degrees to +135 degrees. Note that a forward extension direction (the direction in which the arm parts 27 are raised forward) is the +direction.

A movement range SR of the shoulders 25 (the shoulder joint axis 25C) in the roll direction is from +7 degrees to +135 degrees. Note that an outward extension direction (the direction in which the arm parts 27 are raised outward) is the +direction.

A movement range SY of the shoulders 25 (the shoulder joint axis 25C) in the yaw direction is from −50 degrees to +90 degrees. Note that an inward rotation direction (the direction in which force is applied when arm wrestling) is the +direction.

A movement range EP of the elbow parts 61 in the pitch direction is from 0 degrees to +100 degrees. Note that a bending direction is the +direction.

A movement range WP of the wrist 62 in the pitch direction is from −75 degrees to +50 degrees. Note that the +direction is the direction in which the wrist 62 is raised up.

A movement range WY of the wrist 62 in the roll direction is from −90 degrees to +90 degrees.

A movement range of (the parts 63B) of the hands 63 is from −7 degrees to +100 degrees. Note that the +direction is the direction in which the fingers (the parts 63B) open.

A movement range NR of the neck 24 (the neck joint axis 24C) in the roll direction is from −13 degrees to +13 degrees.

A movement range NP of the neck 24 (the neck joint axis 24C) in the pitch direction is from −14 degrees to +50 degrees. Note that the +direction is the upward direction (the direction of tilting the neck 24 upward). Accordingly, the movement range (range of motion) of the neck 24 in the upward direction (the direction of tilting the neck 24) is greater than the movement range (range of motion) of the neck 24 in the downward direction (the bending direction).

A movement range NY of the neck 24 (the neck joint axis 24C) in the yaw direction is from −43 degrees to +43 degrees.

A movement range TP of the waist 26 (the lumbar joint axis 26C) in the pitch direction is from −25 degrees to +15 degrees. Note that the +direction is the upward direction (the direction of tilting the waist 26 upward). Accordingly, the movement range (range of motion) of the waist 26 in the downward direction (the direction of bending) is greater than the movement range (range of motion) of the waist 26 in the upward direction (the direction of tilting the waist 26 upward).

As described above, setting the dimensions and the movement ranges of the parts of the care robot 11 to the values indicated in FIGS. 15 to 22 makes it possible to make subjects more receptive to the care robot 11.

For example, in many existing robots, the waist has been made thinner, the range of motion has been increased, the truck part has been made smaller, the footprint has been reduced, and the like such that the robot can stretch its fingers to the floor and bow at a deep angle. While the mobility of the waist is improved in such a robot, moving parts are also exposed to the user, giving the subject the impression that the lower body is unstable. Therefore, for example, when the robot bends forward at the waist, the subject is more likely to feel that there is a risk of falling, which is more likely to increase the subject's anxiety. This may reduce the subject's receptivity to the robot.

On the other hand, in the care robot 11, the exposure of the lumbar axis rotation moving part is suppressed by the base outer part 72, which suppresses the sense of a risk that the care robot 11 will fall on the subject.

Additionally, the upper end of the base outer part 72 is lower in the front and higher in the rear, and the lumbar joint axis 26C is disposed further forward than the center of the base part 23 in the front-back direction. This makes it easier for the subject to recognize the front-back direction and the travel direction of the care robot 11.

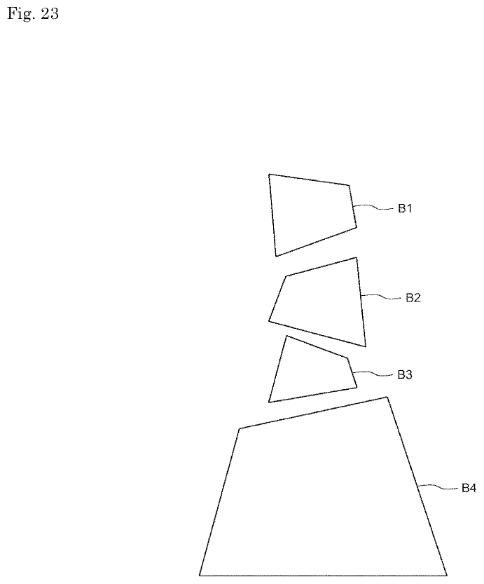

Furthermore, as illustrated in FIG. 23, when viewed from the side, the care robot 11 gives the subject the impression of a stack of blocks B1 to B4, which are close to trapezoidal in shape, stacked so as to be combined with each other in the vertical direction. The block B1 corresponds to the head part 21. The block B2 corresponds to the chest of the torso part 22. The block B3 corresponds to the waist 26 of the torso part 22. The block B4 corresponds to the base part 23. The lowermost block B4 is the largest, which provides the subject with a sense of stability.

This makes it easier to understand the orientation of the care robot 11 while increasing the sense of that the care robot 11 is stable and alive, as compared to the impression given when rectangles are simply stacked on each other.

Accordingly, the care robot 11 can improve the receptivity to the subject without increasing the subject's anxiety.

### <Example of Configuration of Robot Operation System 201>

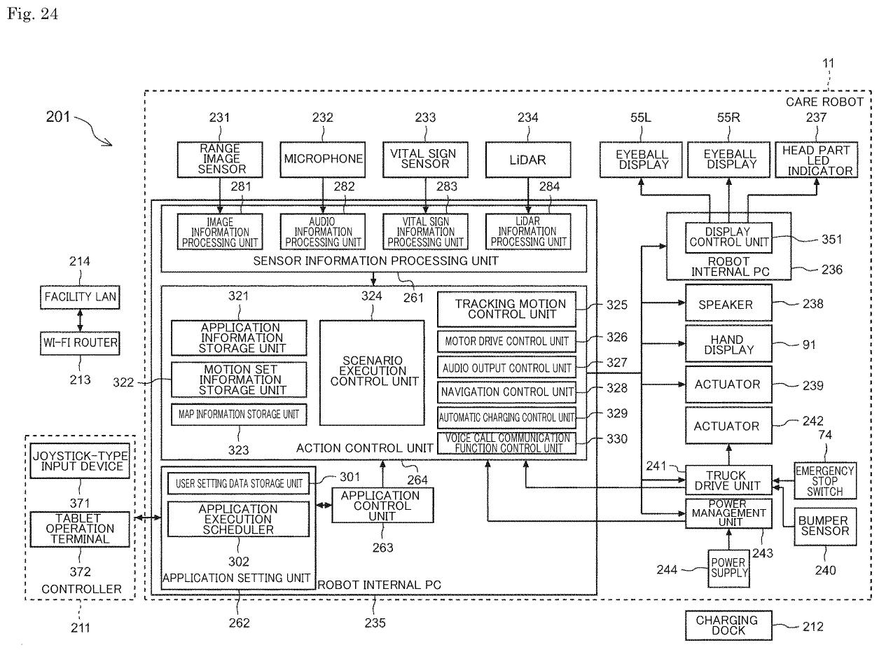

FIG. 24 schematically illustrates an example of the configuration of a robot operation system 201 that operates the care robot 11 described above.

The robot operation system 201 includes the care robot 11, a controller 211, a charging dock 212, a Wi-Fi router 213, and a facility LAN 214.

In addition to the eyeball display 55L, the eyeball display 55R, the emergency stop switch 74, and the hand display 91 described above, the care robot 11 includes a range image sensor 231, a microphone 232, a vital sign sensor 233, LiDAR 234, a robot internal personal computer (PC) 235, a robot internal PC 236, a head part LED indicator 237, a speaker 238, an actuator 239, a bumper sensor 240, a truck drive unit 241, an actuator 242, a power management unit 243, and a power supply 244.

The range image sensor 231 is provided in the head sensor 81 of the care robot 11, for example. The range image sensor 231 captures images of the periphery of the care robot 11 and supplies captured range image data to the robot internal PC 235. The range image data indicates, for example, the captured image and a depth value (distance) of each pixel.

Note that the range image sensor 231 may be constituted by a plurality of sensors. For example, the range image sensor 231 may be constituted by two types of sensors, namely an image sensor and a range sensor. In this case, the image sensor is provided in the head sensor 81, and the distance sensor is provided in the head sensor 81 or the chest sensor 82, for example.

The microphone 232 is provided in the head sensor 81 of the care robot 11, for example. The microphone 232 collects sound from the periphery of the care robot 11 and supplies audio data indicating the collected sound to the robot internal PC 235.

The vital sign sensor 233 is provided in the chest sensor 82 and the hand sensor 83 of the care robot 11, for example. The vital sign sensor 233 includes one or more sensors that measure the vital signs of the subject, such as body temperature, heartbeat, SpO2, blood pressure, respiratory rate, and the like. The vital sign sensor 233 supplies vital sign data indicating the results of measuring the vital signs to the robot internal PC 235.

The LiDAR 234 is provided in the head sensor 81 of the care robot 11, for example. The LiDAR 234 detects the distance to each of points in the periphery of the care robot 11, generates point cloud data indicating detection results, and supplies that data to the robot internal PC 235.

The robot internal PC 235 is implemented as a computer including, for example, a Central Processing Unit (CPU), a Read Only Memory (ROM), a Random Access Memory (RAM), and the like. The robot internal PC 235 controls the parts of the care robot 11 and various types of processing. The robot internal PC 235 includes a sensor information processing unit 261, an application setting unit 262, an application control unit 263, and an action control unit 264.

The sensor information processing unit 261 processes information detected by the various sensors of the care robot 11. For example, the sensor information processing unit 261 evaluates the state of the subject, detects obstacles in the periphery of the care robot 11, and the like on the basis of the information detected by the various sensors. The sensor information processing unit 261 includes an image information processing unit 281, an audio information processing unit 282, a vital sign information processing unit 283, and a LiDAR information processing unit 284.

The image information processing unit 281 performs various types of image processing on the basis of the range image data. For example, the image information processing unit 281 performs processing for detecting the positions, shapes, types, movement, and the like of objects in the periphery of the care robot 11. For example, the image information processing unit 281 performs authentication processing for people in the periphery of the care robot 11, gaze or face orientation detection processing, gesture detection processing, facial expression recognition processing, and the like. The image information processing unit 281 supplies information indicating the results of the image processing to the action control unit 264.

The audio information processing unit 282 executes various types of audio processing on the basis of the audio data. For example, the audio information processing unit 282 executes voice recognition processing to recognize the content of speech by the subject. The audio information processing unit 282 supplies information indicating the results of the audio processing to the action control unit 264.

The vital sign information processing unit 283 performs processing for detecting the vital signs of the subject on the basis of the vital sign data. The vital sign information processing unit 283 supplies vital sign information indicating the results of detecting the vital signs to the action control unit 264.

The LiDAR information processing unit 284 performs processing for detecting the positions, shapes, movement, and the like of objects in the periphery of the care robot 11 on the basis of the point cloud data. The LiDAR information processing unit 284 supplies information indicating the results of the processing for detecting the positions, shapes, movement, and the like of objects in the periphery of the care robot 11 to the action control unit 264.

The application setting unit 262 sets various types of information for executing applications in accordance with instructions from the controller 211. The application setting unit 262 includes a user setting data storage unit 301 and an application execution scheduler 302.

The user setting data storage unit 301 generates and stores individual operating parameters for each of subjects when executing each of applications in accordance with instructions from the controller 211. The operating parameters are set on the basis of information regarding the receptivity of each subject to the care robot 11, for example. The operating parameters include, for example, parameters pertaining to whether or not the subject can be talked to, the volume of the voice, the speed of speech, the speed at which the parts of the body are to move, the speed of travel, how close to the subject the robot can travel, whether or not physical contact is possible, hobbies, and other noteworthy matters.

The application execution scheduler 302 generates and stores schedule information regarding a schedule for executing applications in accordance with instructions from the controller 211. The schedule information includes, for example, information regarding the date/time when the application is to be executed, the type of application to be executed, the subject for whom the application is to be executed, and the like.

The application control unit 263 controls the execution of the application by the care robot 11 by controlling the action control unit 264 on the basis of the operating parameters stored in the user setting data storage unit 301 and the schedule information stored in the application execution scheduler 302. For example, the application control unit 263 controls the type of application to be executed by the care robot 11, the timing at which the application is to be executed, and the subject for whom the application is to be executed. For example, the application control unit 263 controls the method by which the care robot 11 executes the application on the basis of the operating parameters to increase the receptivity of the application for each subject.

The application control unit 263 also updates the operating parameters stored in the user setting data storage unit 301 on the basis of the response of the subject and the like when each application is executed, as detected by the sensor information processing unit 261.

The action control unit 264 controls each part of the care robot 11 in order to cause the care robot 11 to perform actions such as various types of applications. The action control unit 264 includes an application information storage unit 321, a motion set information storage unit 322, a map information storage unit 323, a scenario execution control unit 324, a tracking motion control unit 325, a motor drive control unit 326, an audio output control unit 327, a navigation control unit 328, an automatic charging control unit 329, and a voice call communication function control unit 330.

The application information storage unit 321 stores application information regarding each application executed by the care robot 11. The application information includes, for example, scenarios for executing applications. A “scenario” includes information pertaining to the content of speech/motion, an order in which to execute the speech/motion, branching conditions of the speech/motion, and the like.

“Speech/motion” refers to a combination of speech and motion performed by the care robot 11. In other words, speech/motion refers to a combination of the content of speech (dialogue) output by the care robot 11 and the movement (motion) of the care robot 11 during the speech.

When the care robot 11 performs only speech without moving, “speech/motion” refers only to the speech performed by the care robot 11. When the care robot 11 performs only motion without speaking, “speech/motion” refers only to the motion performed by the care robot 11.

For example, the care robot 11 executes each application by sequentially executing a plurality of speech/motions according to the scenario. The care robot 11 also changes whether to execute speech/motion, the order of execution, and the like according to the situation.

The motion set information storage unit 322 stores motion set information used to execute each speech/motion indicated in the scenario of each application. The motion set information includes, for example, content or audio data of the dialogue spoken by the care robot 11 in the speech/motion, and motion data indicating the movement of each part of the care robot 11.

The map information storage unit 323 stores map information of the care facility or the like where the care robot 11 is used. The map information includes, for example, information pertaining to the location of the room or seat of each subject.

The scenario execution control unit 324 controls the execution of a scenario corresponding to the application to be executed on the basis of the result of processing by the sensor information processing unit 261 and the like. For example, the scenario execution control unit 324 detects a trigger that serves as a branching condition in the scenario. For example, the scenario execution control unit 324 detects the orientation of the faces of people and the subject, the volume of speech by the subject, the content of speech by the subject, and the like as triggers. The scenario execution control unit 324 executes control of whether to execute speech/motion included in the scenario, the order of execution, whether to repeat, pause, or stop, and the like on the basis of results of detecting triggers and the like.

The tracking motion control unit 325 controls the execution of tracking motion on the basis of the result of detecting at least one of the face and the gaze of the subject by the sensor information processing unit 261. “Tracking motion” is processing for tracking the orientation of the face and the gaze of the subject and directing the face of the care robot 11, the screen of the hand display 91, and the like toward the face of the subject.

The motor drive control unit 326 controls the actuator 239, which drives the joints of the care robot 11, to drive the joints of the care robot 11 and control the movement and posture of the care robot 11.

The audio output control unit 327 controls the output of audio from the speaker 238, such as speech audio, music, and the like of the care robot 11.

Note that the care robot 11 is conceived as a grandchild robot, and the voice of the speech thereof is therefore set to the voice of a child, for example (e.g., a child aged 4 to 8). However, it is difficult for a hearing impaired person to hear the high frequency audio of a child's voice.

As such, the audio output control unit 327 modifies the frequency characteristics of the speech audio according to the hearing ability of the subject, for example. For example, when it is difficult for the subject to hear the standard speech audio of the care robot 11, the audio output control unit 327 amplifies the low-frequency band (100 to 1000 Hz), which is easy for an elderly person to hear, and attenuates the high-frequency band (2000 Hz and higher). This makes it easier for the subject to hear the speech audio of the care robot 11.

Note that leaving high-frequency components without modulating the speech audio as a whole ensures that the speech audio does not become too bass-heavy, which can reduce a sense of discomfort compared to the standard speech audio.

For example, the audio output control unit 327 may correct the frequency characteristics of the speech audio on the basis of user settings. Additionally, for example, when it is necessary to reliably convey the content of speech, such as when it is necessary to attract the subject's attention, the audio output control unit 327 may modify the frequency characteristics of the speech audio to make the audio easier for a hearing-impaired person to hear.

The navigation control unit 328 controls the movement direction, movement speed, and movement path of the care robot 11 by controlling the truck drive unit 241 on the basis of the map information stored in the map information storage unit 323 and the like.

The automatic charging control unit 329 controls automatic charging of the power supply 244 on the basis of information indicating the state of the power supply 244 supplied from the power management unit 243. For example, if the automatic charging control unit 329 determines that the power supply 244 needs to be charged, the navigation control unit 328 instructs the care robot 11 to move to the charging dock 212. The automatic charging control unit 329 also controls the power management unit 243 to charge the power supply 244 after the care robot 11 has moved to the charging dock 212.

The voice call communication function control unit 330 controls a voice call function and communication function with other communication devices, servers, and the like via the Wi-Fi router 213 and the facility LAN 214. For example, the voice call communication function control unit 330 controls a video call function and an audio call function using the hand display 91. Note that when the voice call function is executed, a photograph of the person being called is displayed in the hand display 91.

The robot internal PC 236 is implemented as a computer including, for example, a CPU, a ROM, a RAM, and the like. The robot internal PC 236 controls the displays in the care robot 11. The robot internal PC 236 includes a display control unit 351.

The display control unit 351 controls a display function of the care robot 11. For example, the display control unit 351 controls the displays of the pupil part 52L by the eyeball display 55L and the pupil part 52R by the eyeball display 55R. The display control unit 351 also controls the lighting of the head part LED indicator 237.

The head part LED indicator 237 is provided in the head part of the care robot 11, and indicates information regarding the state of the care robot 11 using an LED.

The speaker 238 outputs audio, such as speech audio, music, and the like of the care robot 11, under the control of the audio output control unit 327.

The actuator 239 drives the joints of the care robot 11 under the control of the motor drive control unit 326.

The emergency stop switch 74 supplies an operation signal to the truck drive unit 241 when operated.

The bumper sensor 240 is provided in all directions of the truck 71, for example, performs processing for detecting collisions and the like with objects in all directions of the truck 71, and supplies sensor data indicating the detection results to the truck drive unit 241.

The truck drive unit 241 controls the movement direction and movement speed of the care robot 11 by controlling the actuator 242 of the truck 71 under the control of the action control unit 264. The truck drive unit 241 also stops the movement of the care robot 11 by controlling the actuator 242 when an operation signal is input from the emergency stop switch 74. The truck drive unit 241 further controls the movement direction and movement speed of the care robot 11 by controlling the actuator 242 on the basis of the sensor data from the bumper sensor 240.

The actuator 242 drives drive wheels of the truck 71 under the control of the truck drive unit 241.

The power management unit 243 manages the power supply 244. For example, the power management unit 243 monitors the state of the power supply 244 (e.g., the power remaining in the power supply 244 and the like), and supplies information indicating the state of the power supply 244 to the action control unit 264. For example, the power management unit 243 controls the charging of the power supply 244 using the charging dock 212.

The power supply 244 is provided with a battery, for example, to supply power to each part of the care robot 11.

The controller 211 is a robot controller device that can be carried or worn by the care facility staff. The controller 211 is used, for example, for setting the operating parameters for each subject and the schedule information for each application. Note that a plurality of controllers 211 may be provided, and a plurality of staff members may carry or wear the controllers 211.

The controller 211 includes a joystick-type input device 371 and a tablet terminal device 372.

The joystick type input device 371 is used, for example, for setting the operating parameters for each subject and the schedule information for each application.

The tablet terminal device 372 includes a display, an operating panel, a communication device, and the like. The tablet terminal device 372 is used, for example, for setting the operating parameters for each subject and the schedule information for each application. The tablet terminal device 372 also communicates with the care robot 11.

The charging dock 212 is provided in the care facility and is used to charge the power supply 244 of the care robot 11 during standby. Note that a plurality of charging docks 212 may be provided in the care facility.

The Wi-Fi router 213 is provided in the care facility and is used by the care robot 11 to communicate with the outside. Note that a plurality of Wi-Fi routers 213 may be provided in the care facility.

The facility LAN 214 is provided in the care facility, and various types of communication devices and information processing devices are connected thereto.

### <Dialogical Interaction Processing>

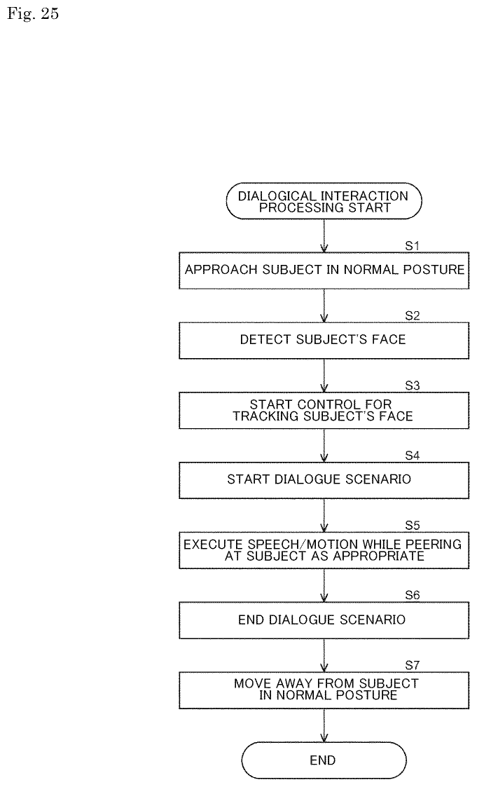

Dialogical interaction processing performed by the care robot 11 will be described next with reference to the flowchart in FIG. 25.

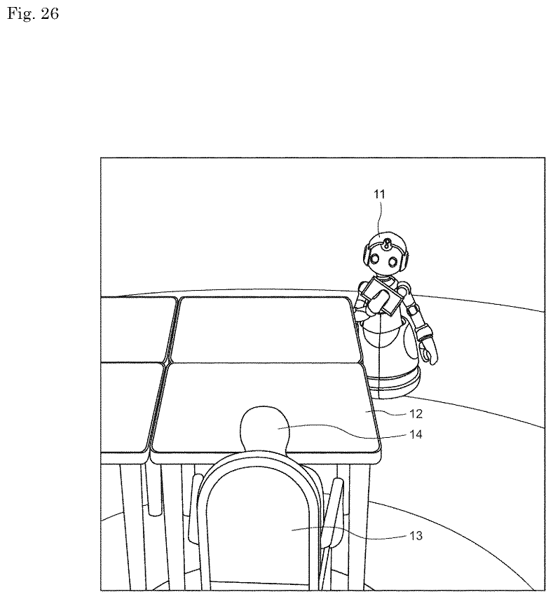

Processing performed when the care robot 11 performs a dialogical interaction with a subject 14 seated in the chair 13 in front of the table 12, as illustrated in FIG. 26, will be described hereinafter.

This processing is started, for example, when a time to perform an application including dialogical interaction for the subject 14 is reached, and the application control unit 263 provides instructions to the action control unit 264 to execute the application.

In step S1, the care robot 11 approaches the subject in the normal posture. Specifically, under the control of the scenario execution control unit 324, the motor drive control unit 326 controls the actuator 239 to set the posture of the care robot 11 to the normal posture, for example.

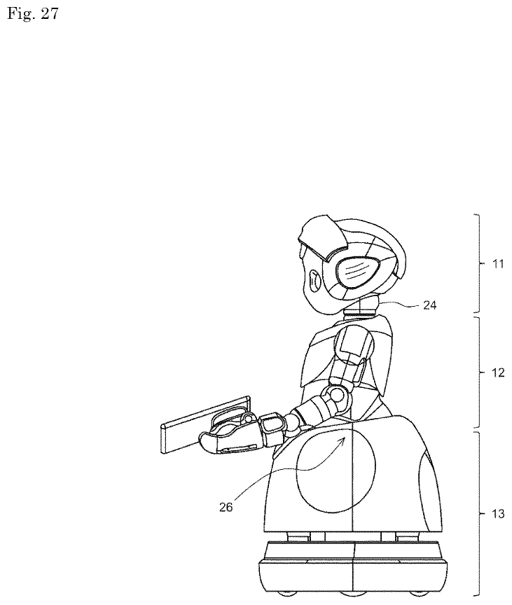

FIG. 27 is a side view of the care robot 11 in the normal posture. In the normal posture, the pitch angle of the neck 24 is set to 0 degrees, and the pitch angle of the waist 26 is set to 0 degrees. As a result, the center of gravity position of the care robot 11 approaches the center in the front-back direction, which makes it possible for the care robot 11 to move stably.

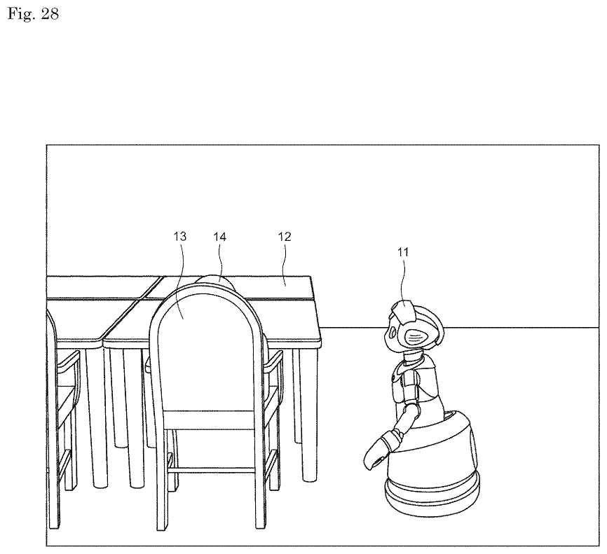

The navigation control unit 328 then controls the truck drive unit 241 to move the care robot 11 to a position 1 to 2 m from the subject 14, for example, as illustrated in FIG. 28.

In step S2, the care robot 11 detects the subject's face. Specifically, the image information processing unit 281 detects the face of the subject 14 on the basis of the range image sensor data from the range image sensor 231, and supplies information indicating the detection result to the action control unit 264.

In step S3, the care robot 11 starts control for tracking the subject's face. For example, under the control of the tracking motion control unit 325, the motor drive control unit 326 controls the actuator 239 to start processing for following the orientation of the face of the subject 14 and controlling the face of the care robot 11 to face in the direction of the face of the subject 14.

Specifically, for example, the care robot 11 tracks the orientation of the face of the subject 14, performs control such that the face of the care robot 11 faces in the direction of the face of the subject 14 using the neck joint axis 24C, and performs control such that the pupil parts 52 face in the direction of the face of the subject 14 using the eyeball displays 55.

Note that the care robot 11 periodically makes a blinking display using the eyeball displays 55, for example.

In step S4, the care robot 11 starts a dialogue scenario under the control of the scenario execution control unit 324.

In step S5, the care robot 11 executes speech/motion while peering at the subject as appropriate. For example, under the control of the scenario execution control unit 324, the motor drive control unit 326 controls the actuator 239 to cause the care robot 11 to perform motion based on the scenario. The audio output control unit 327 causes speech audio based on the scenario to be output from the speaker 238 under the control of the scenario execution control unit 324.

Additionally, for example, the audio information processing unit 282 recognizes the content of the speech by the subject 14 and notifies the action control unit 264 of the result of recognizing the speech content. The scenario execution control unit 324 selects the type of conversational feedback to be made in response to the speech by the subject 14 on the basis of the result of recognizing the speech content. For example, the scenario execution control unit 324 causes speech audio indicating conversational feedback corresponding to the speech content recognized by the audio information processing unit 282 to be output from the speaker 238.

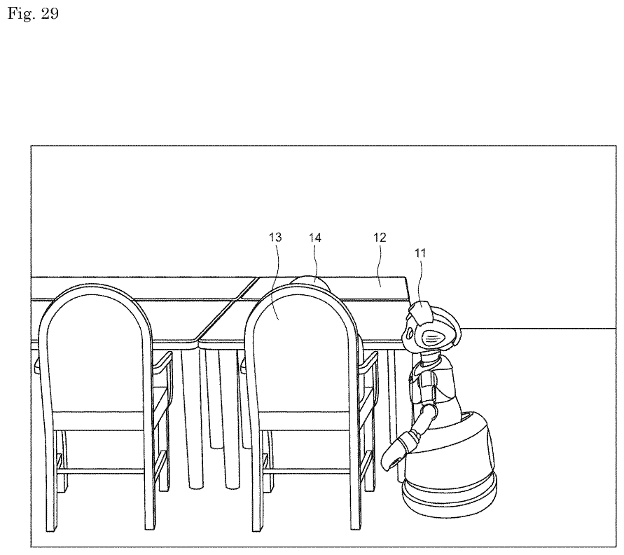

At this time, the care robot 11 performs a peering action for peering into the face of the subject 14 as necessary. Specifically, the navigation control unit 328 controls the truck drive unit 241 to move the care robot 11 to the immediate vicinity of the subject 14, for example, as illustrated in FIG. 29. For example, under the control of the scenario execution control unit 324, the motor drive control unit 326 controls the actuator 239 to set the posture of the care robot 11 to a posture for peering into the face of the subject 14 (called a “peering posture” hereinafter).

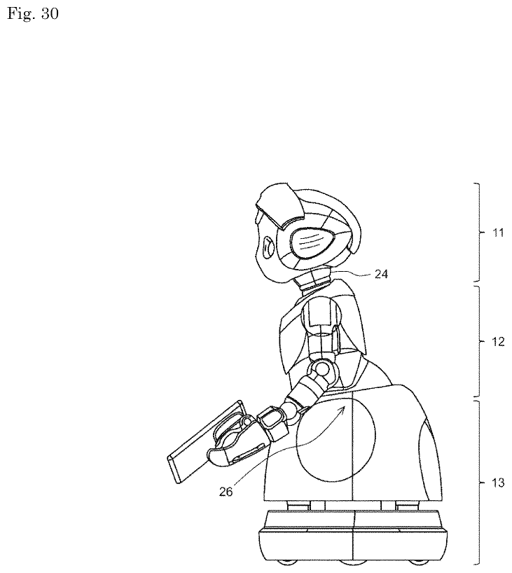

FIG. 30 illustrates an example of the peering posture. For example, the pitch angle of the neck 24 is set to an angle of 25 degrees in the forward extension direction (raised direction), and the pitch angle of the waist 26 is set to an angle of 20 degrees in the bending direction. This causes the care robot 11 to bend forward at the waist 26, and causes the head part 21 to tilt upward. Then, the face of the care robot 11 approaches the face of the subject 14 by moving the head part 21 of the care robot 11 forward compared to the normal posture, such that, for example, the position of the face moves forward to the vicinity of the front end of the footprint. Additionally, the care robot 11 bends forward at the waist 26, making it easier for the subject 14 to recognize the orientation of the care robot 11. This makes it easier for the subject 14 to recognize that the care robot 11 is leaning toward the subject 14 him/herself.

The care robot 11 then engages in dialogue with the subject 14 while peering into the subject 14's face.

In this manner, the face and gaze of the care robot 11 approach the subject in a natural manner, making it possible for the subject 14 to recognize the orientation of the care robot 11 and recognize that the care robot 11 is speaking to the subject 14 him/herself. Additionally, the lumbar axis rotation moving part of the care robot 11 is exposed only a small amount, which prevents the subject 14 from feeling anxious that the care robot 11 will fall, even when the care robot 11 bends forward.

Additionally, the care robot 11 does not simply approach with its entire body, but instead uses the neck 24 and the waist 26 to bring its face toward and peer into the face of the subject 14, which prevents imparting an oppressive feeling on the subject 14.

Note that the care robot 11 may always remain in the peering posture throughout the execution of the dialogue scenario, or may enter the peering posture as necessary.

In the latter case, it is desirable, for example, that the care robot 11 enter the peering posture at least at the beginning of the dialogical interaction, for example, when approaching the subject 14 and making an initial greeting. This enables the care robot 11 to first make the subject 14 aware of the presence of the care robot 11, and then perform the dialogical interaction.

On the other hand, after the care robot 11 becomes the cognitive target of the subject 14, the care robot 11 does not necessarily need to remain in the peering posture. For example, the care robot 11 performs or stops the peering action according to the state of the dialogue with the subject. The care robot 11 may, for example, enter the peering posture when there is something that particularly needs to be communicated (e.g., when asking a question, giving advance notice of what the care robot 11 is about to do, and the like). This enables the care robot 11 to effectively convey what is to be conveyed to the subject 14.

For example, when the care robot 11 nods during the dialogue with the subject 14, the neck joint axis 24C is used to perform an action of extending and retracting the neck 24 in the pitch direction (an action of swinging the neck 24 vertically) while continuing the tracking control.

For example, when the care robot 11 asks the subject 14 a question, an action of angling the neck 24 in the roll direction (tilting the head) is performed using the neck joint axis 24C.

Note that the appropriate peering posture differs depending on the position of the face of the subject 14.

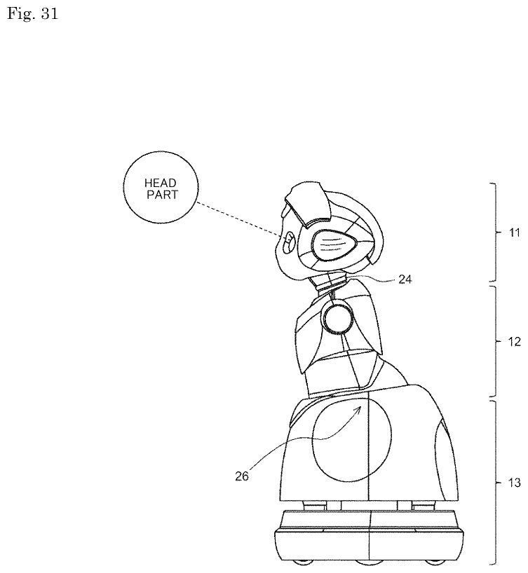

For example, as illustrated in FIG. 31, when the position of the head part (face) of the subject 14 is higher (e.g., when the seated position of the subject 14 is high or the like), the care robot 11 increases the pitch angle of the neck 24 in the forward extension direction (the angle at which the head is lifted about the neck 24). Specifically, for example, the pitch angle of the neck 24 is set to 35 degrees in the forward extension direction while fixing the pitch angle of the waist 26 to 20 degrees in the bending direction.

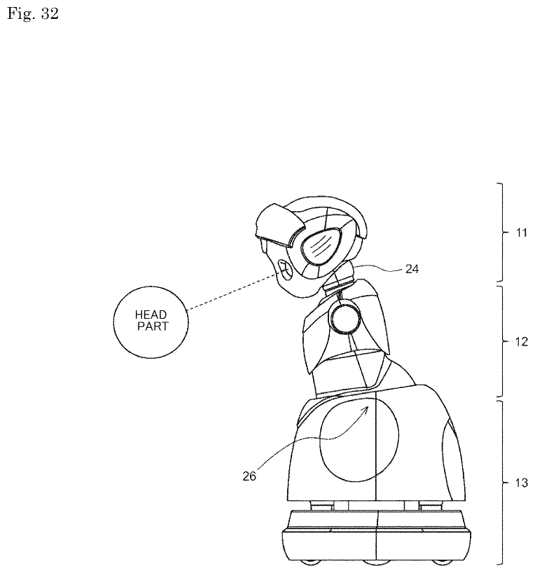

For example, as illustrated in FIG. 32, when the position of the head part (face) of the subject 14 is lower (e.g., when the subject 14 is lying on a bed facing upward), the care robot 11 reduces the pitch angle of the neck 24 in the forward extension direction (the angle at which the head is lifted about the neck 24). Specifically, for example, the pitch angle of the neck 24 is set to 0 degrees in the forward extension direction while fixing the pitch angle of the waist 26 to 20 degrees in the bending direction.

This enables the care robot 11 to peer into the face of the subject 14 as appropriate regardless of the position of the face of the subject 14.

In step S6, the care robot 11 ends the dialogue scenario.

In step S7, the care robot 11 moves away from the subject in the normal posture. Specifically, when in the peering posture, the center of gravity is biased forward, which makes it dangerous to move as-is. Accordingly, under the control of the scenario execution control unit 324, the motor drive control unit 326 controls the actuator 239 to set the posture of the care robot 11 to the normal posture, for example. The navigation control unit 328 then controls the truck drive unit 241 to move the care robot 11 away from the subject 14 while remaining in the normal posture.

This enables the care robot 11 to move safely without falling over.

The dialogical interaction processing then ends.

As described above, the care robot 11 can engage in dialogue with the subject 14 smoothly without causing anxiety to the subject 14, and after ensuring that the subject 14 is fully aware of the orientation of the care robot 11 and that the care robot 11 is speaking to the subject 14.

### 2. Variation

Variations on the foregoing embodiment of the present technique will be described hereinafter.

Although the foregoing described an example in which the care robot 11 operates autonomously, the care robot 11 may, for example, be operated remotely using an external information processing device such as a mobile information terminal or cloud server. In this case, for example, some or all of the functions of the robot internal PC 235 (e.g., the action control unit 264) are implemented in the external device.

The shape and specifications of the care robot can be changed as appropriate according to the content, purpose, and the like of the care. For example, the care robot may be provided with legs and walk using the legs.

The present technique can be applied in a robot capable of dialogue aside from a care robot. For example, when engaging in dialogue with a small child, the robot can engage in the dialogue while giving the child a sense of security and familiarity by peering into the child's face, as described above.

### 3. Other

### <Example of Configuration of Computer>

The series of processing steps described above can be executed by hardware or software. When the series of steps of processing is performed by software, a program of the software is installed in a computer. Here, the computer includes a computer embedded in dedicated hardware or, for example, a general-purpose personal computer capable of executing various functions by installing various programs.

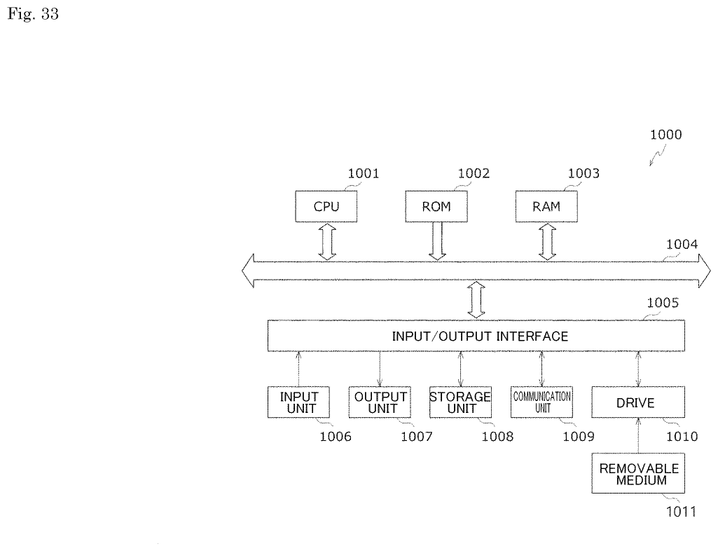

FIG. 33 is a block diagram illustrating an example of a hardware configuration of a computer that executes the series of processing described above according to a program.

In a computer 1000, a Central Processing Unit (CPU) 1001, a Read Only Memory (ROM) 1002, and a Random Access Memory (RAM) (1003) are connected to each other by a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 is constituted by input switches, buttons, a microphone, an image sensor, or the like. The output unit 1007 is constituted by a display, a speaker, or the like. The storage unit 1008 is a hard disk, a non-volatile memory, or the like. The communication unit 1009 may be a network interface. The drive 1010 drives a removable medium 1011 such as a magnetic disk, an optical disk, a magneto-optical disk, semiconductor memory, or the like.

In the computer 1000 configured as described above, for example, a CPU 1001 performs the above-described series of processing by loading a program recorded in the storage unit 1008 to the RAM 1003 via the input/output interface 1005 and the bus 1004 and executing the program, for example.

The program executed by the computer 1000 (the CPU 1001) can be recorded on, for example, the removable medium 1011 serving as a package medium for supply. The program can also be provided via a wired or wireless transmission medium such as a local area network, the Internet, or digital satellite broadcasting.

In the computer 1000, the program can be installed in the storage unit 1008 via the input/output interface 1005 by inserting the removable medium 1011 into the drive 1010. The program can be received by the communication unit 1009 via a wired or wireless transfer medium to be installed in the storage unit 1008. Additionally, the program may be installed in advance in the ROM 1002 or the storage unit 1008.

Note that the program executed by a computer may be a program that performs processing chronologically in the order described in the present specification or may be a program that performs processing in parallel or at a necessary timing such as a called time.

In the present specification, “system” means a set of a plurality of constituent elements (devices, modules (components), or the like), and it does not matter whether or not all the constituent elements are provided in the same housing. Accordingly, a plurality of devices provided in separate housings and connected over a network, and one device in which a plurality of modules are provided in a single housing, both constitute systems.

Furthermore, the embodiments of the present technique are not limited to the above-described embodiments, and various modifications can be made without departing from the essential spirit of the present technique.

For example, the present technique may be configured as cloud computing in which a plurality of devices share and cooperatively process one function via a network.

Additionally, each step described in the above flowchart can be executed by one device or executed in a shared manner by a plurality of devices.

Furthermore, when a single step includes a plurality of processes, the plurality of processes included in the single step can be executed by a single device, or in a distributed manner by a plurality of devices.

### Combination Example of Configuration

The present technique can also have the following configurations.

(1)

A robot including:
a head part;
a torso part including a waist having a lumbar joint axis capable of rotating in at least a pitch direction;
a neck provided between the head part and the torso part, and including a neck joint axis capable of rotating in at least the pitch direction;
a base part supporting the torso part; and
an action control unit that controls a peering action of peering at a face of a user by controlling the neck joint axis and the lumbar joint axis.
   (2)

The robot according to (1),
wherein the action control unit performs control to engage in dialogue with the user in a state where the robot is peering at the face of the user.
   (3)

The robot according to (2),
wherein the action control unit performs tracking control for pointing the head part toward the face of the user during the dialogue with the user.
   (4)

The robot according to (3),
wherein the action control unit directs eyes toward the user in the tracking control.
   (5)

The robot according to (3) or (4),
wherein when nodding during the dialogue with the user, the action control unit causes the neck to move up and down in the pitch direction while continuing the tracking control.
   (6)

The robot according to any one of (3) to (5),
wherein when asking the user a question, the action control unit tilts the neck in a roll direction.
   (7)

The robot according to any one of (2) to (6),
wherein during the dialogue with the user, the action control unit performs or stops the peering action in accordance with a state of the dialogue.
   (8)

The robot according to any one of (1) to (7),
wherein in the peering action, the action control unit causes the robot to bend forward at the waist.
   (9)

The robot according to (8),
wherein in the peering action, the action control unit tilts the head part back at the neck.
   (10)

The robot according to (9),
wherein the action control unit controls an angle for tilting the head back at the neck according to a position of the face of the user.
   (11)

The robot according to any one of (1) to (10),
wherein when approaching the user or moving away from the user, the action control unit performs control to move the robot in a normal posture in which the neck and the waist are substantially upright.
   (12)

The robot according to any one of (1) to (11),
wherein a lower part of the waist is inserted into the base part, and the lumbar joint axis is in a position lower than an upper end of the base part.
   (13)

The robot according to (12),
wherein the waist includes a lumbar axis rotation moving part that is a spherical part rotated by the lumbar joint axis.
   (14)

The robot according to (13),
wherein when the lumbar axis rotation moving part rotates, a gap between the torso part and the base part is kept substantially constant.
   (15)

The robot according to (13) or (14),
wherein a ratio of a depth of the base part to a diameter of the lumbar axis rotation moving part is greater than 1 and less than 2.5.
   (16)

The robot according to any one of (12) to (15),
wherein when the base part is viewed from a side, an inclined part that is inclined at an upward angle from forward to backward is formed at the upper end of the base part.
   (17)

The robot according to (16),
wherein an angle of inclination of the inclined part is greater than 0 degrees and less than 30 degrees.
   (18)

The robot according to (16) or (17),
wherein when the base part is viewed from a side, a point of intersection between an auxiliary line indicating the inclination of the inclined part and a front end of the base part is at a position higher than the lumbar joint axis.
   (19)

The robot according to any one of (1) to (18),
wherein the lumbar joint axis is disposed further forward than a center of the base part in a front-back direction.
   (20)

A method for controlling a robot, the robot including a head part, a torso part including a waist having a lumbar joint axis capable of rotating in at least a pitch direction, a neck provided between the head part and the torso part and including a neck joint axis capable of rotating in at least the pitch direction, and a base part supporting the torso part, the method causing the robot to:
execute a peering action of peering at a face of a user by controlling the neck joint axis and the lumbar joint axis.

The effects described in the present specification are merely illustrative and not limiting, and other effects may be obtained.

### REFERENCE SIGNS LIST

11 Care robot
14 Subject
21 Head part
22 Torso part
23 Base part
24 Neck
24C Neck joint axis
25L, 25R Shoulder
25LC, 25RC Shoulder joint axis
26 Waist
26C Lumbar joint axis
27L, 27R Arm part
41L, 41R Eyeball part
51L, 51R Pupil part
71 Truck
72 Base outer part
Robot internal PC
239 Actuator
242 Truck drive unit
243 Actuator
261 Sensor information management unit
263 Application control unit
264 Action control unit
324 Scenario execution control unit
325 Tracking motion control unit
326 Motor drive control unit
327 Audio output control unit
328 Navigation control unit

1. A robot comprising:
a head part;
a torso part including a waist having a lumbar joint axis capable of rotating in at least a pitch direction;
a neck provided between the head part and the torso part, and including a neck joint axis capable of rotating in at least the pitch direction;
a base part supporting the torso part; and
an action control unit that controls a peering action of peering at a face of a user by controlling the neck joint axis and the lumbar joint axis.

2. The robot according to claim 1,
wherein the action control unit performs control to engage in dialogue with the user in a state where the robot is peering at the face of the user.

3. The robot according to claim 2,
wherein the action control unit performs tracking control for pointing the head part toward the face of the user during the dialogue with the user.

4. The robot according to claim 3,
wherein the action control unit directs eyes toward the user in the tracking control.

5. The robot according to claim 3,
wherein when nodding during the dialogue with the user, the action control unit causes the neck to move up and down in the pitch direction while continuing the tracking control.

6. The robot according to claim 3,
wherein when asking the user a question, the action control unit tilts the neck in a roll direction.

7. The robot according to claim 2,
wherein during the dialogue with the user, the action control unit performs or stops the peering action in accordance with a state of the dialogue.

8. The robot according to claim 1,
wherein in the peering action, the action control unit causes the robot to bend forward at the waist.

9. The robot according to claim 8,
wherein in the peering action, the action control unit tilts the head part back at the neck.

10. The robot according to claim 9,
wherein the action control unit controls an angle for tilting the head back at the neck according to a position of the face of the user.

11. The robot according to claim 1,
wherein when approaching the user or moving away from the user, the action control unit performs control to move the robot in a normal posture in which the neck and the waist are substantially upright.

12. The robot according to claim 1,
wherein a lower part of the waist is inserted into the base part, and the lumbar joint axis is in a position lower than an upper end of the base part.

13. The robot according to claim 12,
wherein the waist includes a lumbar axis rotation moving part that is a spherical part rotated by the lumbar joint axis.

14. The robot according to claim 13,
wherein when the lumbar axis rotation moving part rotates, a gap between the torso part and the base part is kept substantially constant.

15. The robot according to claim 13,
wherein a ratio of a depth of the base part to a diameter of the lumbar axis rotation moving part is greater than 1 and less than 2.5.

16. The robot according to claim 12,
wherein when the base part is viewed from a side, an inclined part that is inclined at an upward angle from forward to backward is formed at the upper end of the base part.

17. The robot according to claim 16,
wherein an angle of inclination of the inclined part is greater than 0 degrees and less than 30 degrees.

18. The robot according to claim 16,
wherein when the base part is viewed from a side, a point of intersection between an auxiliary line indicating the inclination of the inclined part and a front end of the base part is at a position higher than the lumbar joint axis.

19. The robot according to claim 1,
wherein the lumbar joint axis is disposed further forward than a center of the base part in a front-back direction.

20. A method for controlling a robot, the robot including a head part, a torso part including a waist having a lumbar joint axis capable of rotating in at least a pitch direction, a neck provided between the head part and the torso part and including a neck joint axis capable of rotating in at least the pitch direction, and a base part supporting the torso part, the method causing the robot to:
execute a peering action of peering at a face of a user by controlling the neck joint axis and the lumbar joint axis.
